(19) United States
(12) Patent Application Publication
(10) Pub. No.: US 2015/0257075 A1
(43) Pub. Date: Sep. 10, 2015

(54) COMMUNICATION DEVICE AND COMMUNICATION CONTROL METHOD

(71) Applicant: KYOCERA CORPORATION, Kyoto-shi, Kyoto (JP)

(72) Inventors: Shuuji Ishikawa, Kyoto-shi (JP); Daisuke Mori, Kyoto-shi (JP)

(21) Appl. No.: 14/436,434

(22) PCT Filed: Oct. 16, 2013
(86) PCT No.: PCT/JP2013/078109

§ 371 Date: Apr. 16, 2015

(30) Foreign Application Priority Data
Oct. 16, 2012 (JP) 2012-229348
Oct. 16, 2012 (JP) 2012-229349
Oct. 16, 2012 (JP) 2012-229350
Oct. 16, 2012 (JP) 2012-229359

(51) Int. Cl. H04W 36/32; H04W 72/02; H04W 48/16; H04W 4/02

(52) U.S. Cl. CPC H04W 36/32; H04W 4/02; H04W 72/02; H04W 48/16; H04W 84/045

(57) ABSTRACT

Provided is a communication device that is capable of waiting for communication in a communication system with a lower priority, under certain conditions. The communication device is provided with: a storage unit (31) that stores location information indicating the location of a prescribed base station when the communication device succeeds in connecting to the prescribed base station; and a control unit (33) that searches for the prescribed base station when it has been determined that the device body is within a prescribed range of the prescribed base station on the basis of location information for the prescribed base station stored in the storage unit (31), and location information representing the current location of the device body.

### TECHNICAL FIELD

The present invention relates to a communication device and a communication control method.

### BACKGROUND ART

As communication systems used by communication devices such as mobile telephone devices, there are communication systems of the CDMA standard (CDMA system), communication systems of the LTE (Long Term Evolution) standard (LTE system), etc.

These communication systems have the priority order for searching specified in advance.

The communication device starts a search in sequence from base stations corresponding to the communication system having high priority (for example, refer to Patent Document 1).

For the LTE system, the CS fallback function is defined in 3GPP TS 23.272, and it is possible to notify an incoming call request from the CDMA system by the LTE system according to this function.

Furthermore, in the case of making a voice outgoing call using the CS fallback function, a handover (handoff) instruction from the LTE system to the CDMA system in relation to the outgoing call request from the communication device is sent to the communication device. The electronic device receiving the handover instruction switches from the LTE system to the CDMA system, and performs predetermined call origination processing.
Patent Document 1: Japanese Unexamined Patent Application, Publication No. 2009-10785
Non-Patent Document 1: 3GPP TS 23.272 V11.2.0, “Circuit Switched (CS) fallback in Evolved Packet System (EPS); Stage 2,” 2012-09

### DISCLOSURE OF THE INVENTION

### Problems to be Solved by the Invention

In the case of being within the range of an area of communication system having a high order of priority, and also being within the range of an area of a communication system having a lower order of priority, since the electronic device follows priority, there is a risk of not being able to standby for communication by the lower order communication system.

However, for reasons such as the radio wave situation, it may be desired to perform standby for communication by the communication system having a lower order of priority, even with the aforementioned such situation.

The present invention has an object providing a communication device that can perform standby for communication by a communication system having a lower order of priority under fixed conditions.

In addition, in the case of having failed in an outgoing calling or incoming call by CS fallback, there has been a risk of the communication device failing again in an outgoing calling or incoming call if standing by in the LTE system again.

The present invention has an object of providing a communication device and communication control method that avoid trouble related to switching of communication systems, and thus can comfortably perform outgoing calls and call receiving.

### Means for Solving the Problems

In order to solve the above-mentioned problem, a communication device according to the present invention is a configuration including: a storage unit that, in a case of succeeding in connection to a predetermined base station, stores positional information indicating a position of the predetermined base station; and a control unit that, based on the positional information of the predetermined base station stored in the storage unit and positional information indicating a current position of a device main body, searches for the predetermined base station in a case of determining that the device main body is within a predetermined range from the predetermined base station.

In order to solve the above-mentioned problem, a communication device according to the present invention is a configuration including: a storage unit that, in a case of succeeding in connection to a predetermined base station, stores positional information indicating a position of a succeeding location; and a control unit that, based on the positional information stored in the storage unit and positional information indicating a current position of a device main body, searches for the predetermined base station in a case of determining that the device main body is within a predetermined range from the succeeding location.

The predetermined base station may be a femtocell base station that has a smaller coverage area than a macrocell base station.

In order to solve the above-mentioned problem, a communication device according to the present invention is a configuration including a control unit that searches for a femtocell base station, in a case of recognizing as being within a predetermined area in which a femtocell is installed.

In order to solve the above-mentioned problem, a communication device according to the present invention that searches following a predetermined order for a plurality of communication systems including a first communication system that supports data communication and does not support voice communication, and a second communication system that supports data communication and voice communication is a configuration including: a storage unit that, in a case of succeeding in a search for a base station corresponding to the second communication system, stores positional information indicating a position of the base station; and a control unit that searches for a base station of the plurality of communications systems excluding the first communication system, in a case of determining, based on the positional information of the base station stored in the storage unit and positional information indicating a current position of a device main body, that the device main body is within a predetermined range from the base station.

In order to solve the above-mentioned problem, a communication control method according to the present invention is a configuration executed in a communication device, including: a storage step of, in a case of succeeding in connection to a predetermined base station, storing positional information indicating a position of the predetermined base station; and a control step of searching for the predetermined base station in a case of determining, based on the positional information of the predetermined base station stored and positional information indicating a current position of a device main body, that the device main body is within a predetermined range from the predetermined base station.

In order to solve the above-mentioned problem, a communication control method according to the present invention is a configuration executed in a communication device, including: a storage step of, in a case of succeeding in connection to a predetermined base station, storing positional information indicating a position of a succeeding location; and a control step of searching for the predetermined base station in a case of determining, based on the positional information stored and positional information indicating a current position of a device main body, that the device main body is within a predetermined range from the succeeding location.

In order to solve the above-mentioned problem, a communication control method according to the present invention is a configuration executed by a communication device, including a control step of searching for a femtocell base station in a case of recognizing as being within a predetermined area in which a femtocell base station is installed.

In order to solve the above-mentioned problem, a communication control method according to the present invention is a configuration executed in a communication device that searches following a predetermined order for a plurality of communication systems including a first communication system that supports data communication and does not support voice communication, and a second communication system that supports data communication and voice communication, including: a storage step of, in a case of succeeding in a search for a base station corresponding to the second communication system, storing positional information indicating a position of the base station; and a control step of searching for a base station of the plurality of communication systems excluding the first communication system in a case of determining, based on the positional information of the base station stored and positional information indicating a current position of a device main body, that the device main body is within a predetermined range from the base station.

In order to solve the above-mentioned problem, a communication device according to the present invention is a configuration including: a first communication control unit; and a second communication control unit that starts a search prioritizing a first communication system upon searching for communication systems, in which the first communication control unit controls the second communication control unit so as to start a search for another communication system, by excluding the first communication system from a search target, in a case of a search request being generated.

The communication device may be a configuration including an operation unit, in which the search request is caused by an operation on the operation unit.

The second communication control unit may be a consideration that maintains a state excluding the first communication system from a search target, in a case of performing standby for communication by way of a second communication system as a result of starting a search.

The second communication system may be a communication system supporting a femtocell constituted by a base station that has a smaller coverage area than a macrocell base station.

The first communication control unit may be a configuration that controls the second communication control unit so that the first communication system is included in a search target, in a case of performing standby for communication according to the second communication control unit by a communication system other than the communication system supporting the femtocell.

The first communication control unit may be a configuration that controls the second communication control unit so that the first communication system is included in a search target, in a case of transitioning to a power savings state in which standby for communication is not possible by any communication system, as a result of starting a search.

The first communication control unit may be a configuration that controls the second communication control unit so that the first communication system is included in a search target, and then controls the second communication control unit so as to start a search from the first communication system.

The communication device may be a configuration including a setting unit, in which the first communication control unit controls the second communication control unit so that the first communication system is included in a search target, on the condition of being set by the setting unit so that the first communication system is included in the search target.

In order to solve the above-mentioned problem, a communication control method according to the present invention, for a communication device including a first communication control unit and a second communication control unit that starts a search prioritizing a first communication system upon searching for communication systems, is a configuration in which the first communication control unit controls the second communication control unit so as to start a search for another communication system, by excluding the first communication system from a search target, in a case of a search request being generated.

In order to solve the above-mentioned problem, a communication device according to the present invention is a configuration including: a first communication control unit; and a second communication control unit that starts a search by prioritizing a first communication system upon searching for communication systems, in which the first communication control unit controls the second communication control unit so as to exclude the first communication system from a subsequent search target, in a case of performing standby for communication by way of a second communication system as a result of a search.

The first communication control unit may be a configuration that controls the second communication control unit so as to exclude the first communication system from the search target, and then, in a case of being an outside range state or performing standby for communication by way of a third communication system, controls the second communication control unit so that the first communication system is included in a subsequent search target.

The second communication system may be a communication system constituted by a base station that has a smaller coverage area than a macrocell base station.

The third communication system may be a communication system constituted by a macrocell base station.

It may be a configuration including a setting unit, in which the first communication control unit controls the second communication control unit so that the first communication system is included in a search target, on the condition of being set by the setting unit so that the first communication system is included in the search target.

The first communication control unit may be a configuration that controls the second communication control unit so that the first communication system is included in a search target, in a case of performing standby for communication according to the second communication control unit by a communication system other than the second communication system.

The first communication control unit may be a configuration that controls the second communication control unit so that the first communication system is included in a search target, in the case of transitioning to a power savings state in which standby for communication is not possible for any communication system as a result of a search.

The first communication control unit may be a configuration that controls the second communication control unit so that the first communication system is included in a search target, and then controls the second communication control unit so as to start a search from the first communication system.

In order to solve the above-mentioned problem, a communication control method according to the present invention, for a communication device including a first communication control unit and a second communication control unit that starts a search prioritizing a first communication system upon searching for communication systems, is a configuration in which the first communication control unit controls the second communication control unit so as to exclude the first communication system from a subsequent search target, in a case of performing standby for communication by way of a second communication system as a result of a search.

A communication device according to the present invention that switches according to a CS fallback function from a first communication system incapable of voice telephone calls to a second communication system capable of voice telephone calls, upon an outgoing call or an incoming call, includes a control unit that searches by prioritizing the second communication system over the first communication system, in a case of failing in an outgoing call or incoming call by way of the CS fallback function.

The communication device may include a display unit that displays a status of the search while searching for the second communication system.

A communication device according to the present invention that switches according to a CS fallback function from a first communication system incapable of voice telephone calls to a second communication system capable of voice telephone calls, upon an outgoing call or an incoming call, includes a control unit that, in a case of failing in an incoming call by way of the CS fallback function, notifies of failing in the incoming call.

The control unit may search for the second communication system in a case of failing in an incoming call by way of the CS fallback function.

The control unit may stand by for the first communication system, in a case of not being able to capture the second communication system by way of a search for the second communication system.

A communication control method according to the present invention, for a communication device that switches according to a CS fallback function from a first communication system incapable of voice telephone calls to a second communication system capable of voice telephone calls, upon an outgoing call or an incoming call, searches for the second communication system in a case of failing in an outgoing call or incoming call by way of the CS fallback function.

A communication control method according to the present invention, for a communication device that switches according to a CS fallback function from a first communication system incapable of voice telephone calls to a second communication system capable of voice telephone calls, upon an outgoing call or an incoming call, in a case of failing in an incoming call by way of the CS fallback function, notifies of failing in the incoming call.

### Effects of the Invention

According to the present invention, it is possible for a communication device to perform standby for communication by a communication system having low-order priority under fixed conditions.

According to the present invention, a communication device avoids troubles related to switching between communication systems, and can carry out outgoing calls or call receiving more comfortably.

### BRIEF DESCRIPTION OF THE DRAWINGS

FIG. 1 is a perspective view showing the appearance of a mobile telephone device according to a first embodiment;

FIG. 2 is a block diagram showing functions of the mobile telephone device according to the first embodiment;

FIG. 3 is a view offering an explanation for operations when determining whether a femtocell base station has entered within a predetermined range from the current position of the mobile telephone device, centering around the mobile telephone device, according to a second embodiment;

FIG. 4 is a view offering an explanation for operations upon determining whether the mobile telephone device has entered within a predetermined range, centering around a past connecting location, according to a third embodiment;

FIG. 5 is a flowchart offering an explanation for operations when a search for a femtocell base station succeeds, and storing positional information of the femtocell base station, according to a fourth embodiment;

FIG. 6 is a flowchart offering an explanation for operations when referencing positional information of a femtocell base station stored in the storage unit, and determining whether the mobile telephone device is within a predetermined area, according to the fourth embodiment;

FIG. 7 is a block diagram showing functions of the mobile telephone device, according to a fifth embodiment;

FIG. 8 is a schematic diagram of a table referenced upon deciding whether to change the settings of the LTE system, according to the fifth embodiment;

FIG. 9 is a schematic diagram of a table referenced upon deciding whether to perform restart (reboot) of a communication system, according to the fifth embodiment;

FIG. 10 is a view offering an explanation for a sequence in a case of performing standby of a communication system supporting femtocells, according to the fifth embodiment;

FIG. 11 is a view offering an explanation for a sequence in a case of performing standby within range of a domestic public network, according to the fifth embodiment;

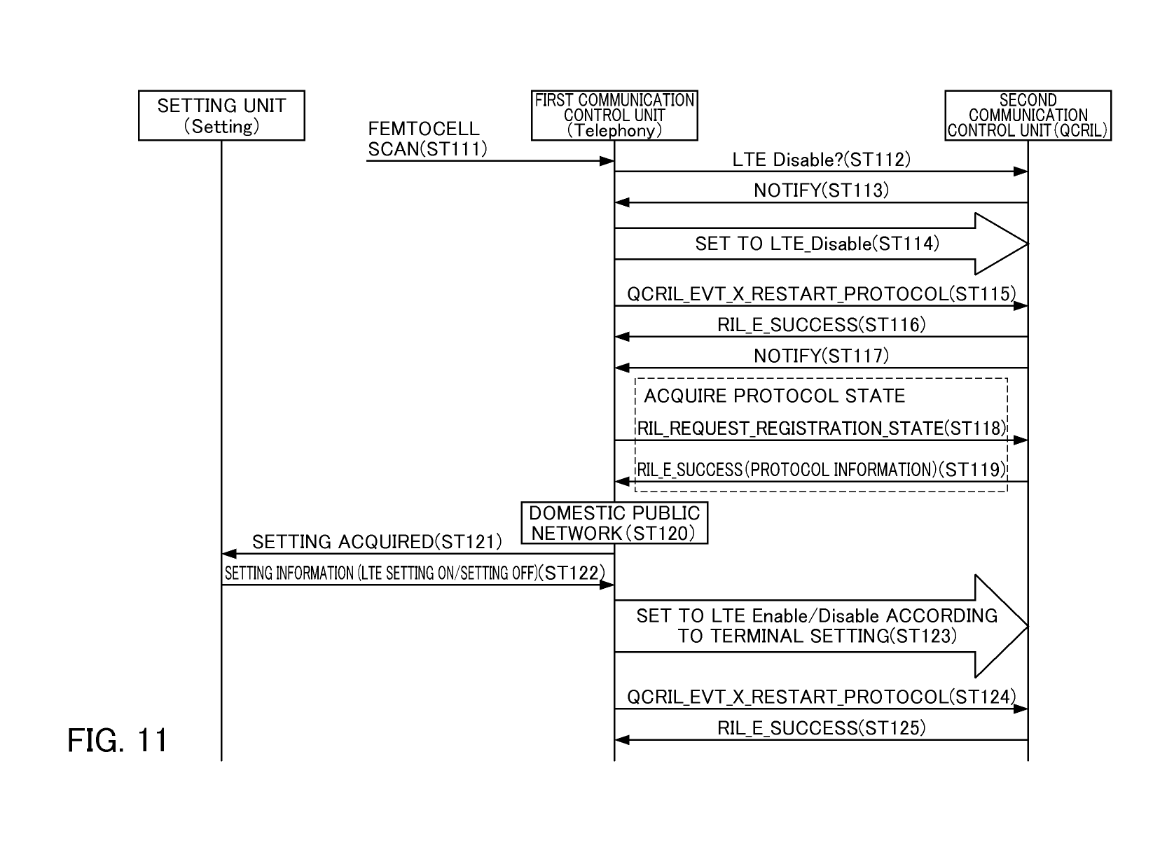

FIG. 12 is a block diagram showing functions of the mobile telephone device according to a sixth embodiment;

FIG. 13 is a schematic diagram of a table referenced upon deciding whether to change the setting of the LTE system, according to the sixth embodiment;

FIG. 14 is a schematic diagram of a table referenced upon deciding whether to perform restart (reboot) of a communication system, according to the sixth embodiment;

FIG. 15 is a view offering an explanation for a sequence in a case of performing standby of a communication system supporting femtocells when outside range of the LTE system, according to the sixth embodiment;

FIG. 16 is a view offering an explanation for a sequence in a case of performing standby within range of a domestic public network, according to the sixth embodiment;

FIG. 17 is a flowchart offering an explanation for a setting change of the LTE system for within range and outside range of an area of a femtocell, according to the sixth embodiment;

FIG. 18 is a perspective view showing the appearance of a smartphone according to a seventh embodiment;

FIG. 19 is a front view showing the appearance of the smartphone according to the seventh embodiment;

FIG. 20 is a rear view showing the appearance of the smartphone according of the seventh embodiment;

FIG. 21 is a block diagram showing the configuration of the smartphone according to the seventh embodiment;

FIG. 22 is a flowchart showing voice outgoing call processing according to the seventh embodiment; and

FIG. 23 is a flowchart showing voice incoming call processing according to the seventh embodiment.

### PREFERRED MODE FOR CARRYING OUT THE INVENTION

### First Embodiment

Hereinafter, a first embodiment of the present invention will be explained. It should be noted that a mobile telephone device 1 will be explained as one example of the communication device in the present embodiment.

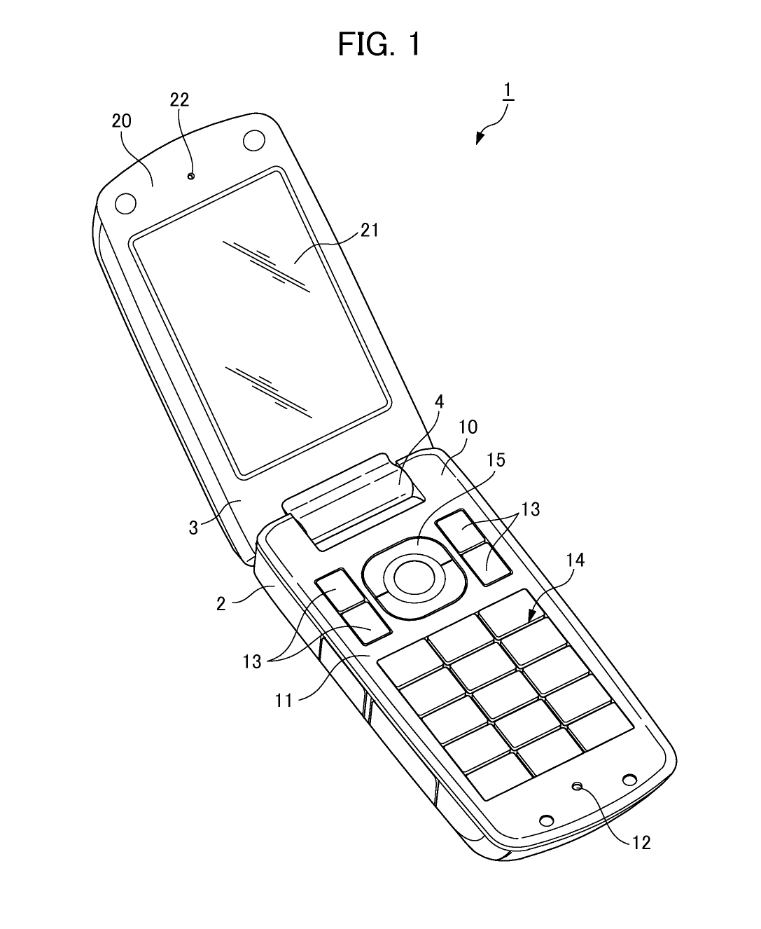

FIG. 1 is an external perspective view of the mobile telephone device 1 according to the present embodiment.

It should be noted that, although FIG. 1 shows an embodiment of a so-called folding type mobile telephone device, the embodiment of the mobile telephone device according to the present invention is not limited thereto. For example, the mobile telephone device may be of: a slider type in which one of the bodies slides to one direction in a state in which the bodies are mutually superimposed; a rotating (turning) type in which one of the bodies is rotated around an axis line along the direction of superimposing the bodies; and a type (straight type) in which an operation unit and a display unit are disposed in one body without having a connecting portion.

The mobile telephone device 1 is configured to include an operation unit side body 2 and a display unit side body 3. The operation unit side body 2 is configured to include, on a surface portion 10 thereof, an operation unit 11 and a microphone 12 to which sound produced by a user of the mobile telephone device 1 is input when the user is having a telephone call or using a speech recognition application. The operation unit 11 is configured to include: function setting operation buttons 13 for activating various functions, such as various setting functions, a phonebook function, and an e-mail function; input operation buttons 14 for inputting digits of a telephone number, characters for an e-mail, or the like; and a determination operation button 15 for performing determinations in various operations, scrolling, or the like.

In addition, the display unit side body 3 is configured to include, on the surface portion 20 thereof: a display unit 21 for displaying a variety of information; and a receiver 22 for outputting voice of the other party of the call.

In addition, an upper end of the operation unit side body 2 and a lower end of the display unit side body 3 are interconnected via a hinge mechanism 4. Furthermore, by rotating the operation unit side body 2 and the display unit side body 3 relatively to each other, which are interconnected via the hinge mechanism 4, the mobile telephone device 1 can be in a state where the operation unit side body 2 and the display unit side body 3 are opened with respect to each other (opened state), and a state where the operation unit side body 2 and the display unit side body 3 are folded together (closed state).

The mobile telephone device 1 configured in this way operates so as to perform standby for communication by a communication system having a lower order of priority (e.g., communication system supporting femtocells) under fixed conditions.

Communication system supporting femtocells is the matter of a communication system that installs a small-scale cell in each household as a dead-zone countermeasure in a radio area such as a high-rise apartment building, and performs voice and data communication using the BB (Broadband) line, etc. of the users.

The femtocell is realized by ultracompact base stations installed in a household or small office. The ultracompact base stations are connected with fixed lines (telephone lines) connecting to land-line phones in a household, optical fiber, CATV cable, or the like, and emit radio waves that can be received by the mobile telephone device 1.

The radio waves emitted by the ultracompact base station are similar to a normal external base station arranged outdoors, except for the output level. Therefore, the mobile telephone device 1 can perform voice and data communication with the ultracompact base station in the same sequence as the case of performing voice and data communication with an external base station.

In addition, in order to realize the CSFB (Circuit Switched Fallback) function, the external base station must notify the area of which CDMA system that the mobile telephone device 1 in standby with the LTE system is physically in. CSFB is circuit switching fallback, and is a plan for switching the data communications network (e.g., LTE system) to circuit switching such as the 3G system.

Herein, processing upon switching to the CDMA system by CSFB will be explained, in the case of there being an incoming call of voice communication to the mobile telephone device 1 performing standby by the LTE system.

In the case of there being an incoming call to the mobile telephone device 1, based on mapping data of the area between the LTE system and CDMA system, the external base station specifies the area of the CDMA system to which the mobile telephone device 1 currently belongs, and notifies the mobile telephone device 1 using the LTE system so as to do CSFB in the area of the specified CDMA system.

The mobile telephone device 1 switches from the LTE system to the CDMA system in response to this notification, and performs registration at the external base station.

The external base station updates position registration information according to this registration, and notifies of the incoming call by way of the CDMA system to the mobile telephone device 1.

The mobile telephone device 1 performs predetermined informing according to this notification. The mobile telephone device 1 initiates a telephone call in response to an operation by the user.

In the case of installing femtocell base stations in a dead-zone of a radio area such as a high-rise apartment, the voice protocol (CDMA system) of the public network often is outside range.

In other words, in such an area, in the case of the mobile telephone device 1 performing standby by the LTE system, when trying to perform the aforementioned such CSFB, since the external base station does not have mapping data of the LTE system and femtocell base stations, CSFB fails, and the mobile telephone device 1 no longer can perform sending/receiving of voice communication.

In addition, with a communication device having the CSFB function, the priorities of communication systems for standby are established in advance such as “LTE system>3G system (CDMA system, UMTS, etc.)”. Consequently, due to the LTE system having higher priority than the femtocells corresponding to a 3G system, in the case of being within the range of the area of the LTE system and within the area of a femtocell base station corresponding to the 3G system, the mobile telephone device 1 has difficulty standing by with a femtocell corresponding to the 3G system.

The mobile telephone device 1 operates so as to perform standby for communication by the communication system having a lower order priority under fixed conditions. The specific configuration will be explained hereinafter.

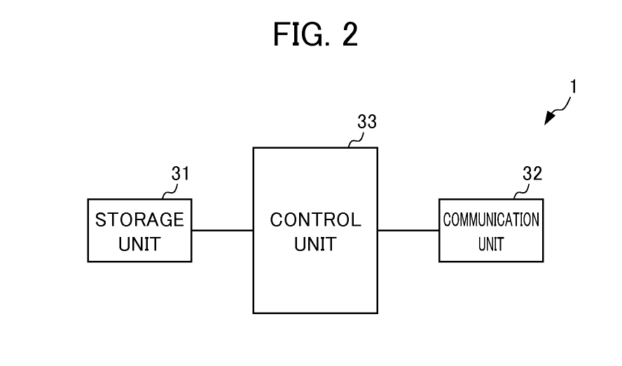

The mobile telephone device 1 includes a communication unit 32 and a control unit 33, as shown in FIG. 2.

The communication unit 32 performs communication using a communication method conforming to predetermined standards. For example, the communication unit 32 handles communication standards of the cellular phones such as 2G, 3G and 4G as the predetermined standards. The cellular phone communication standards include LTE (Long Term Evolution), W-CDMA, CDMA2000, PDC, GSM, PHS (Personal Handy-phone System), communication standard supporting femtocells, etc.

The control unit 33 searches for femtocell base stations in the case of recognizing the mobile telephone device 1 as being within a predetermined area in which a femtocell base station is installed.

By configuring in this way, the mobile telephone device 1 can favorably perform data communication and voice communication due to performing searching for femtocell base stations in the case of recognizing as being within a predetermined area in which femtocell base stations are installed.

### Second Embodiment

The mobile telephone device 1 according to the present embodiment includes a storage unit 31, a communication unit 32 and a control unit 33, as shown in FIG. 2. It should be noted that the communication unit 32 is the same configuration as the first embodiment.

In the case of succeeding in connection to a predetermined base station, the storage unit 31 stores positional information indicating the position of this predetermined base station. It should be noted that it may be a configuration in which the positional information of a plurality of base stations is stored in the storage unit 31.

Based on the positional information of a predetermined base station stored in the storage unit 31 and positional information indicating the current position of the device main body, in the case of determining that the device main body is within a predetermined range from a predetermined base station, the control unit 33 searches for this predetermined base station.

The predetermined base station, for example, is a femtocell base station having a smaller coverage area than a microcell base station. In the present embodiment, it is explained with the installation location of the femtocell base station being within the home of a user possessing the mobile telephone device 1; however, it is not limited to being within the home of the user.

In addition, the mobile telephone device 1 has a GPS function corresponding to a satellite positioning system. The control unit 33 acquires positional information indicating the current position of the device main body, using the GPS function.

In the case of succeeding in connecting to a femtocell base station, the mobile telephone device 1 notifies this femtocell base station so as to send the positional information. The femtocell base station sends positional information of the femtocell base station to the mobile telephone device 1 in response to the notification from the mobile telephone device 1. It should be noted that the mobile telephone device 1 does not perform this notification in the case of positional information being automatically sent to the mobile telephone device 1 from the femtocell base station.

The mobile telephone device 1 stores the received positional information in the storage unit 31 to be associated with the ID of the femtocell base station. It should be noted that the positional information is information indicating the location at which the femtocell base station is arranged, and is expressed by latitude and longitude. In addition, information indicating the height (elevation) at which the femtocell base station is arranged may also be included in the positional information.

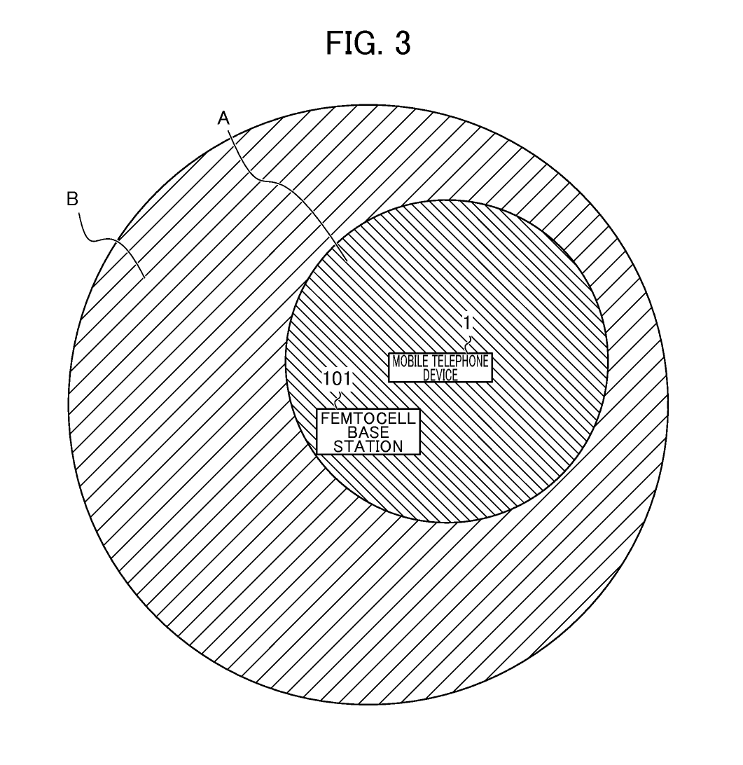

The mobile telephone device 1 references the positional information of the femtocell base station 101 stored in the storage unit 31 at a predetermined timing, and performs a search for the femtocell base station 101 in the case of determining that the femtocell base station 101 falls within a predetermined range (A in FIG. 3) from the current position of the device main body. It should be noted that the range A is defined as being included in the area (B in FIG. 3) of the femtocell base station 101.

In addition, in the example shown in FIG. 3, the mobile telephone device 1 is made a configuration that determines whether the femtocell base station 101 falls within a predetermined range centered around the device main body (itself); however, it is not limited thereto. The mobile telephone device 1 may be a configuration that determines whether itself falls within a predetermined range centered around the femtocell base station 101.

Predetermined timing is considered to be when recharging of the mobile telephone device 1 is started, when the mobile telephone device 1 is connected with an external device by way of a predetermined interface (e.g., HDMI or MHL), when the mobile telephone device 1 connects to AP (access point) based on Wi-Fi, when the mobile telephone device 1 unlocks the lock of one's home using a function of short-distance wireless communication, or the like.

By configuring in this way, the mobile telephone device 1 can search for femtocell base stations automatically, in the case of femtocell base stations that have connected in the past falling within the predetermined range.

In addition, the mobile telephone device 1 performs a search for a femtocell base station in the case of being within the range of an area of the LTE system, and within the range of an area of a femtocell base station that has connected in the past; therefore, it is possible to favorably perform data communication and voice communication.

### Third Embodiment

The mobile telephone device 1 of the present embodiment includes the storage unit 31, the communication unit 32 and the control unit 33 as shown in FIG. 2. It should be noted that the communication unit 32 is the same configuration as the first embodiment.

In the case of the mobile telephone device 1 succeeding in connecting to a predetermined base station, the storage unit 31 stores positional information indicating the position of this location of succeeding. It should be noted that it may be a configuration in which the positional information of a plurality of locations is stored in the storage unit 31.

The control unit 33 searches for a predetermined base station in the case of having determined that the device main body is within a predetermined range from a location at which having succeeded in connecting to the predetermined base station in the past, based on the positional information stored in the storage unit 31 and positional information indicating the current position of the device main body.

The predetermined base station is a femtocell base station having a smaller coverage area than a microcell base station. In the present embodiment, it is explained with the installation location of the femtocell base station being within the home of a user possessing the mobile telephone device 1; however, it is not limited to being within the home of the user.

In addition, the mobile telephone device 1 has a GPS function corresponding to a satellite positioning system, similarly to the second embodiment. The control unit 33 acquires positional information indicating the current position of the device main body using the GPS function.

In the case of succeeding in connection to a femtocell base station, the mobile telephone device 1 acquires the positional information of the location at which having succeeded by way of the GPS function.

The mobile telephone device 1 stores the acquired positional information in the storage unit 31 to be associated with the ID of the femtocell base station. It should be noted that the positional information is information indicating the location at which having succeeded in connecting to a femtocell base station, and is expressed by latitude and longitude. In addition, information indicating the height (elevation) of the mobile telephone device 1 may be included in the positional information.

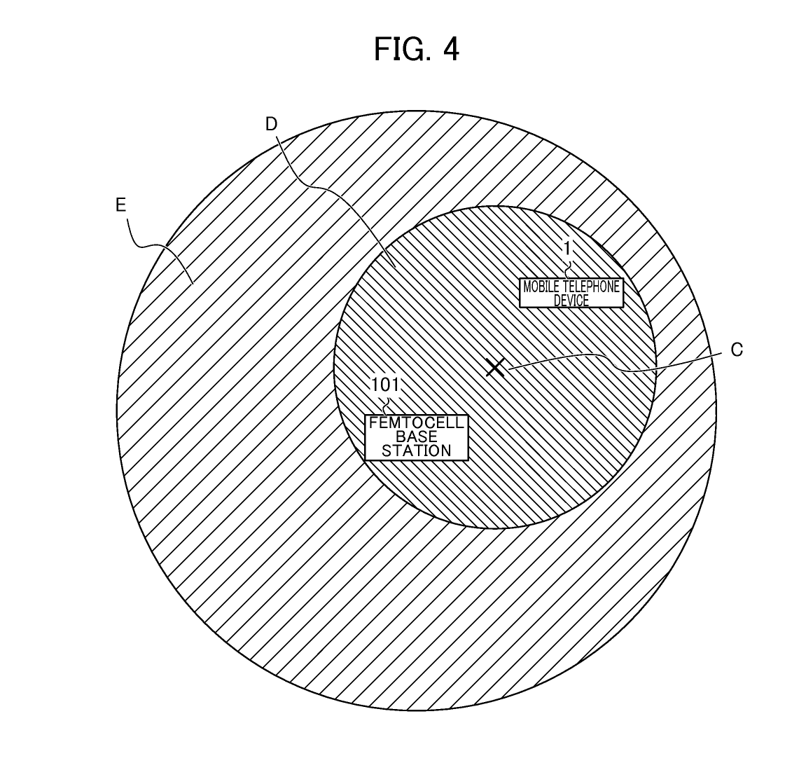

The mobile telephone device 1 references the positional information (C in FIG. 4) stored in the storage unit 31 at a predetermined timing, and performs a search for the femtocell base station 101 associated with the positional information in the case of having determined that the current position of the device main body (itself) falls within the predetermined range (D in FIG. 4) from the positional information. It should be noted that the range D is defined to be included in the area (E in FIG. 4) of the femtocell base station 101.

Predetermined timing is considered to be when recharging of the mobile telephone device 1 is started, when the mobile telephone device 1 is connected with an external device by way of a predetermined interface (e.g., HDMI or MHL), when the mobile telephone device 1 connects to AP (access point) based on Wi-Fi, when the mobile telephone device 1 unlocks the lock of one's home using a function of short-distance wireless communication, or the like.

By configuring in this way, the mobile telephone device 1 can search for femtocell base stations automatically in the case of falling with a predetermined range from a location at which connection succeeded in the past.

In addition, the mobile telephone device 1 performs searching for femtocell base stations in the case of being within the range of an area of the LTE system, and within the range of an area of a femtocell base station; therefore, it is possible to favorably perform data communication and voice communication.

### Fourth Embodiment

The mobile telephone device 1 of the present embodiment includes the storage unit 31, the communication unit 32 and the control unit 33, and searches following a predetermined sequence for the base stations of a plurality of communication systems, including a first communication system that handles data communication and does not handle voice communication, and a second communication system that handles data communication and voice communication. It should be noted that the configuration of the communication unit 32 is the same as the first embodiment. The mobile telephone device 1 searches by prioritizing the base stations of the first communication system over the base stations of the second communication system following a predetermined sequence.

In the case of having succeeded in a search for a base station corresponding to the second communication system, the storage unit 31 stores positional information indicating the position of this base station.

The control unit 33 searches for base stations of a plurality of other communication systems excluding the first communication system, in the case of having determined that the device main body is within a predetermined range from the base station, based on the positional information of base stations stored in the storage unit 31 and positional information indicating the current position of the device main body.

First communication system is a communication system of the LTE standard (LTE system), for example. Second communication system is a communication system supporting femtocells, for example. Herein, communication system supporting femtocells is a communication system constituted by femtocell base stations. It should be noted that the constituting base stations are not limited to femtocells, and may be nanocells or picocells. The communication standard corresponding to the second communication system, for example, is the CDMA2000_{—}1x standard or UMTS standard.

In addition, base station corresponding to the second communication system is a femtocell base station having a smaller coverage area than a microcell base station. In the present embodiment, it is explained with the installation location of the femtocell base station being within the home of a user possessing the mobile telephone device 1; however, it is not limited to being within the home of the user.

In addition, the mobile telephone device 1 has a GPS function corresponding to a satellite positioning system. The control unit 33 acquires positional information indicating the current position of the device main body, using the GPS function.

In the case of succeeding in connection to a femtocell base station, the mobile telephone device 1 notifies this femtocell base station so as to send the positional information. The femtocell base station sends positional information of the femtocell base station to the mobile telephone device 1 in response to the notification from the mobile telephone device 1. It should be noted that the mobile telephone device 1 does not perform this notification in the case of positional information being automatically sent to the mobile telephone device 1 from the femtocell base station.

The mobile telephone device 1 stores the received positional information in the storage unit 31 to be associated with the ID of the femtocell base station. It should be noted that the positional information is information indicating the location at which the femtocell base station is arranged, and is expressed by latitude and longitude. In addition, information indicating the height (elevation) at which the femtocell base station is arranged may also be included in the positional information.

The mobile telephone device 1 references the positional information of the femtocell base station 101 stored in the storage unit 31 at a predetermined timing, and performs a search for the femtocell base station 101 in the case of determining that the femtocell base station 101 falls within a predetermined range (A in FIG. 3) from the current position of the device main body (itself). It should be noted that the range A is defined as being included in the area (B in FIG. 3) of the femtocell base station 101.

In addition, in the example shown in FIG. 3, the mobile telephone device 1 is made a configuration that determines whether the femtocell base station 101 falls within a predetermined range centered around itself; however, it is not limited thereto. The mobile telephone device 1 may be a configuration that determines whether itself falls within a predetermined range centered around the femtocell base station 101.

Predetermined timing is considered to be when recharging of the mobile telephone device 1 is started, when the mobile telephone device 1 is connected with an external device by way of a predetermined interface (e.g., HDMI or MHL), when the mobile telephone device 1 connects to AP (access point) based on Wi-Fi, when the mobile telephone device 1 unlocks the lock of one's home using a function of short-distance wireless communication, or the like.

By configuring in this way, in the case of a femtocell base station to which having connected in the past falling within a predetermined range, the mobile telephone device 1 can search for the femtocell base station automatically.

In addition, the mobile telephone device 1 performs searching for a femtocell base station in the case of being within the range of an area of the LTE system, and within the range of an area of a femtocell base station to which having connected in the past; therefore, it is possible to favorably perform data communication and voice communication.

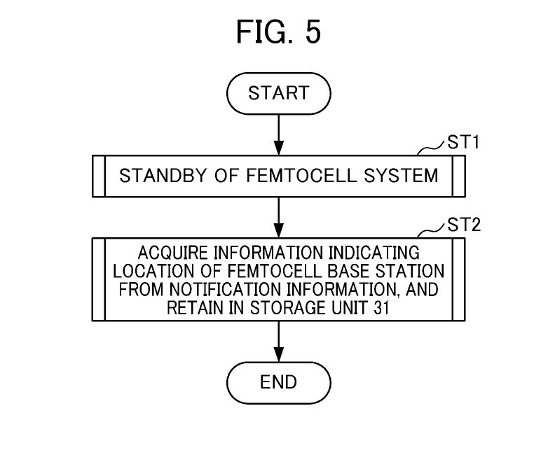

Next, the operations when a search for a femtocell base station succeeds, and the mobile telephone device 1 stores the positional information of the femtocell base station will be explained while referencing the flowchart shown in FIG. 5.

In Step ST1, the search for a femtocell base station succeeds, and the control unit 33 performs standby for communication by the communication system supporting the femtocell.

In Step ST2, the control unit 33 acquires information indicating the location at which the femtocell base station is arranged (latitude and longitude) based on the notification information sent from the femtocell base station, and retains in the storage unit 31. It should be noted that information indicating the height (elevation) at which the femtocell base station is arranged may also be included in the information indicating the location.

In addition, the control unit 33 may be a configuration that notifies the femtocell base station so as to send positional information, in the case of information indicating the location not being included in the notification information.

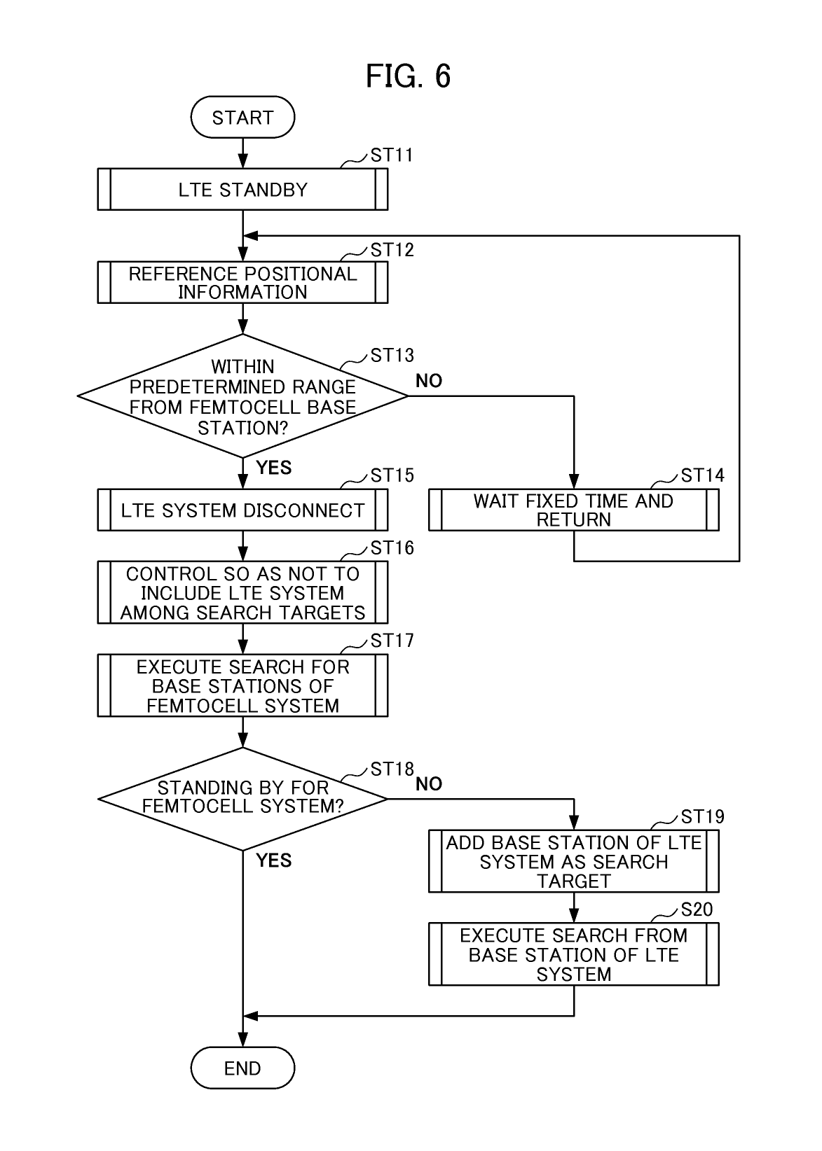

Next, the operations when referencing the positional information of a femtocell base station stored in the storage unit 31 in the case of the mobile telephone device 1 performing standby by the LTE system, and determining whether the mobile telephone device 1 is within a predetermined range will be explained while referencing the flowchart shown in FIG. 6. It should be noted that, in the following, it is established so that the positional information indicating the position of a femtocell base station for which the mobile telephone device 1 has succeeded in a search in the past is stored in the storage unit 31.

In Step ST11, the control unit 33 performs standby for communication by the LTE system.

In Step ST12, the control unit 33 references the positional information of the femtocell base station 101 stored in the storage unit 31 at a predetermined timing. Predetermined timing, as mentioned above, is considered to be when recharging of the mobile telephone device 1 is started, when the mobile telephone device 1 is connected with an external device by way of a predetermined interface (e.g., HDMI or MHL), when the mobile telephone device 1 connects to AP (access point) based on Wi-Fi, when the mobile telephone device 1 unlocks the lock of one's home using a function of short-distance wireless communication, or the like.

In Step ST13, the control unit 33 determines whether the device main body is within a predetermined range from the femtocell base station, based on the positional information of the femtocell base station, and positional information of the current position of the device main body. In the case of having determined that the device main body is within the predetermined range from the femtocell base station (YES), the processing advances to Step ST15, and in the case of having determined that the device main body is not within the predetermined range from the femtocell base station (NO), the processing advances to Step ST14.

In Step ST14, the control unit 33 waits a fixed time, and then performs the processing of Step ST12. Fixed time, for example, is 30 seconds.

In Step ST15, the control unit 33 performs disconnection processing of the LTE system. In other words, the mobile telephone device 1 enters a state not connected to any communication system.

In Step ST16, the control unit 33 controls so as not include the base stations of the LTE system among the search targets.

In Step ST17, the control unit 33 executes a search for femtocell base stations.

In Step S18, the control unit 33 determines whether having succeeding in standby of the communication system supporting femtocells, according to the search in the process of Step ST17. In the case of having determined as succeeding in standby for the communication system supporting femtocells (YES), voice and data communication is performed thereafter using the communication system supporting femtocells. In the case of having determined as not succeeding in standby of the communication system supporting femtocells (NO), the processing advances to Step ST19.

In Step ST19, the control unit 33 controls so as to include base stations of the LTE system among the search targets.

In Step ST20, the control unit 33 executes searching for base stations of the LTE system, following the search priority.

By configuring in this way, the mobile telephone device 1 can disconnect from the LTE system and search for femtocell base stations, in the case of a femtocell base station to which having connected in the past falling within a predetermined range.

In addition, in the case of being within the range of an area of the LTE system, and being within the range of an area of a femtocell base station to which having connected in the past, the mobile telephone device 1 disconnects the LTE system, and performs searching for the femtocell base station; therefore, it is possible to favorably performs data communication and voice communication.

### Fifth Embodiment

A fifth embodiment of the present invention will be explained hereinafter. It should be noted that the functional configuration of the mobile telephone device 1 in the present embodiment differs from the aforementioned embodiments.

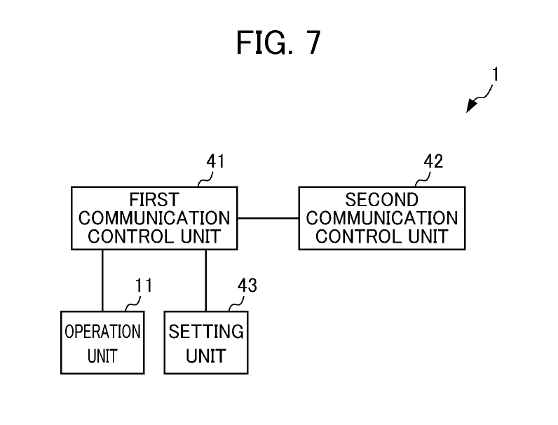

The mobile telephone device 1 of the present embodiment includes a first communication control unit 41 and a second communication control unit 42, as shown in FIG. 7.

Herein, it is assumed that an Android system is built into the mobile telephone device 1 according to the present embodiment. The Android system is configured by a Linux part and a Modem part. A Telephony functional part and a QCRIL functional part are implemented in the Linux part.

With the CDMA system, the Modem part establishes a communication connection following the request from the Telephony functional part implemented in the Linux part.

With the LTE system, the establishment of a PPP session with a 2G/3G terminal such as a conventional CDMA system, GSM, UMTS or the like, and the sequence of acquiring IP addresses differ, and the establishment processing of a communication connection is performed asynchronously by the Modem part and Linux part.

The Telephony functional part corresponds to the first communication control unit 41. The QCRIL functional part corresponds to the second communication control unit 42.

The second communication control unit 42 starts the search prioritizing the first communication system, upon searching for communication systems. First communication system indicates the LTE system.

In the case of a request for a search occurring, the first communication control unit 41 controls the second communication control unit 42 so as to start a search for other communication systems, by excluding the first communication system from the search targets. Other communication system is a communication system other than the LTE system and, for example, is the communication system supporting femtocells, etc.

Consequently, in the case of a request for a search occurring, the mobile telephone device 1 performs a search for the other communication systems excluding the first communication system which has first priority; therefore, even in the case of being within an area of a communication system having high-order priority, and also being within an area of a communication system having lower-order priority, it is possible to perform standby for communication by the communication system having lower-order priority.

The mobile telephone device 1 includes the operation unit 11 as shown in FIGS. 1 and 7.

In the case of a search request caused by operation of the operation unit 11 occurring, the first communication control unit 41 controls the second communication control unit 42 so as to start searching for the other communication system, by excluding the first communication system from the search targets.

More specifically, the mobile telephone device 1 has a function of deciding the timing to perform searching for communication systems according to operation of the operation unit 11. The user causes this function to activate by operating the operation unit 11.

This assumes a situation desiring standby for communication by a communication system having low-order priority, in a case of the user currently being within an area of a communication system having high-order priority, and also being within an area of the communication system having low-order priority.

Consequently, in the case of a search request occurring in response to the operation of the user, since the mobile telephone device 1 performs a search for the other communication system by excluding the first communication system having first priority, even in the case of being within the area of a communication system having high-order priority, and also being within the area of a communication system having low-order priority, it is possible to perform standby for communication by the communication system having low-order priority.

The second communication control unit 42 may be a configuration that maintains a state excluding the first communication system from the search targets, in the case of performing standby for communication by the second communication system as a result of starting a search.

This is because of assuming a situation of the user desiring standby for communication not by the first communication system, but rather the second communication system, and thus causing standby for communication to be performed with the second communication system as much as possible.

Consequently, in the case of a search request occurring in response to the operation of the user and performing standby for communication by the second communication system, since the mobile telephone device 1 continues to exclude the first communication system from the search targets, even in the case of being within the area of a communication system having high-order priority, and also being within the area of a communication system having low-order priority, it is possible to perform standby for communication by the communication system having low-order priority also in the case of performing a search again.

The second communication system, for example, is a communication system supporting base stations (e.g., femtocell base stations) having a smaller coverage area than a microcell base station (hereinafter, communication system supporting femtocells). Herein, the communication standard corresponding to the second communication system, for example, is the CDMA2000_{—}1x standard or UMTS standard.

Locations arise at which the radio wave strength becomes very weak and communicating is difficult at the border region between microcell base stations, and the interior and basement of buildings. The femtocell base stations are arranged at such locations.

For example, a case will be considered of being within the area of a communication system having first priority (e.g., LTE system) and a second-order communication system (e.g., communication system supporting femtocells), the radio wave strength of the first-order communication system being very weak, and the radio wave strength of the second-order communication system being strong.

A normal communication device will perform standby for communication by the communication system having first priority (e.g., LTE system) so long as communication is possible even if the radio wave strength is very weak.

The mobile telephone device 1 according to the present embodiment will not perform a search for the first communication system having first priority in the case of a search being requested according to the operation of the user, and thus will execute a search for the second communication system. As a result thereof, the mobile telephone device 1 can perform standby for communication by the second communication system having strong radio wave strength.

The first communication control unit 41 may be a configuration that controls the second communication control unit 42 so that the first communication system is included among the search targets, in the case of performing standby for communication with a communication system other than the communication system supporting femtocells according to the second communication control unit 42.

This is assuming a case of the mobile telephone device 1 having performed a search by excluding the first communication system from the search targets, but not being able to capture the second communication system.

In such a case, the mobile telephone device 1 makes so as to be able to standby for communication by the first communication system, by way of returning back to the settings with the first communication system as the first-order communication system, as normal.

By being configured in this way, in the case of performing a search according to the operation of the user, and performing standby for communication by a communication system other than the communication system supporting femtocells, the mobile telephone device 1 controls the second communication control unit 42 so that the first communication system (LTE system) is included among the search targets; therefore, when it is not possible to use the communication system supporting femtocells, it is possible to achieve use of the LTE system.

The first communication control unit 41 may be a configuration that controls the second communication control unit 42 so that the first communication system is included among the search targets, in the case of transitioning to a power saving state in which standby for communication is not possible for any communication system as a result of starting a search.

This is assuming a case of the mobile telephone device 1 having performed a search by excluding the first communication system from the search targets, but including the second communication system and not being able to capture all communication systems.

In such a case, the mobile telephone device 1 establishes so as to be able to standby for communication by way of the first communication system by returning back to the settings with the first communication system as the first-order communication system, as normal.

By being configured in this way, in a case of performing a search according to the operation of the user, and not being able to capture all of the communication systems including the communication system supporting femtocells, since the mobile telephone device 1 controls the second communication control unit 42 so that the first communication system (LTE system) is included among the search targets, it is possible to achieve use of the LTE system.

The first communication control unit 41 may be a configuration that controls the second communication control unit 42 so as to start a search from the first communication system, after controlling the second communication control unit 42 so that the first communication system is included among the search targets.

According to such a configuration, for example, in a case of performing a search according to the operation of the user, and performing standby for communication by a communication system other than the communication system supporting femtocells, the mobile telephone device 1 starts a search from the first communication system when changing the settings so that the first communication system (LTE system) is included among the search targets; therefore, it is possible to achieve use of the LTE system actively.

The mobile telephone device 1 includes a setting unit 43, as shown in FIG. 7.

The first communication control unit 41 controls the second communication control unit 42 so that the first communication system is included among the search targets, on the condition of being set by the setting unit 43 so that the first communication system is included among the search targets.

The setting unit 43 has setting information of whether to turn ON (active) or turn OFF (inactive) use of the LTE system according to the operation of the user. In the present embodiment, it is established so that the use of the LTE system is ON (active).

It should be noted that setting by the setting unit 43 so that the first communication system is included among the search targets indicates use of the LTE system being set to ON (active).

Consequently, since the mobile telephone device 1 temporarily makes the first communication system that had been excluded from the search targets to be included among the search targets upon the condition of use of the LTE system being set to ON (active) according to the operation of the user, it is possible to perform standby for communication with a communication system having low-order priority under a fixed condition, while reflecting the intentions of the user.

### Examples

Herein, the processing when the mobile telephone device 1 stands by in a communication system supporting femtocells with an operation by a user will be explained.

In the case of performing scan of the communication system supporting femtocells with an operation by a user, the mobile telephone device 1 disables the LTE system. After scan completion, depending on whether performing standby of the communication system supporting femtocells, or performing power saving or standby of a domestic public network, the mobile telephone device 1 enables or disables the LTE system. To enable the LTE system indicates including the LTE system among the search targets, and to disable the LTE system indicates excluding the LTE system from the search targets.

In addition, domestic public network is a communication system other than the communication system supporting femtocells and, for example, is a communication system constituted by base stations having a broader coverage area than a femtocell base station such as a microcell base station (CDMA2000_{—}1x-EVDO, GSM, etc.).

More specifically, the mobile telephone device 1 disables the LTE system in the case of performing standby of the communication system supporting femtocells. In the case of performing power savings or standby of a domestic public network, the mobile telephone device 1 enables the LTE system as a general rule, but does not enable the LTE system in the case of the LTE system turning OFF (inactive) according to settings, due to prioritizing the settings of the mobile telephone device 1.

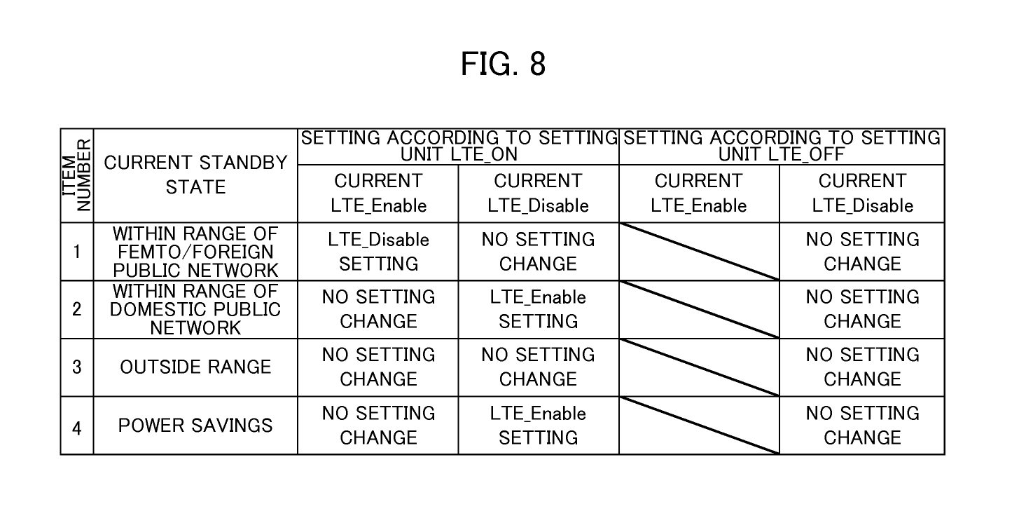

Herein, FIG. 8 shows a schematic view of a table referenced upon the mobile telephone device 1 deciding whether to change the setting of the LTE system in the case of performing standby of the communication system supporting femtocells according to the operation of the user.

As shown in FIG. 8, the mobile telephone device 1 sets the LTE system to disable when the current standby state is with range of the communication system supporting femtocells or a foreign public network, in a case of the setting according to the setting unit 43 being LTE_ON (active), and the LTE system being enabled. In other words, the setting is changed to a state in which the LTE system cannot be used.

In addition, as shown in FIG. 8, when the current standby state is within range of a domestic public network or a power savings state, in a case of the settings according to the setting unit 43 being LTE_ON (active), and the LTE system being disabled, the mobile telephone device 1 sets the LTE system to enabled. In other words, the setting is changed to a state in which the LTE system can be used. It should be noted that the mobile telephone device 1 does not perform changing of the settings in the case of being another state.

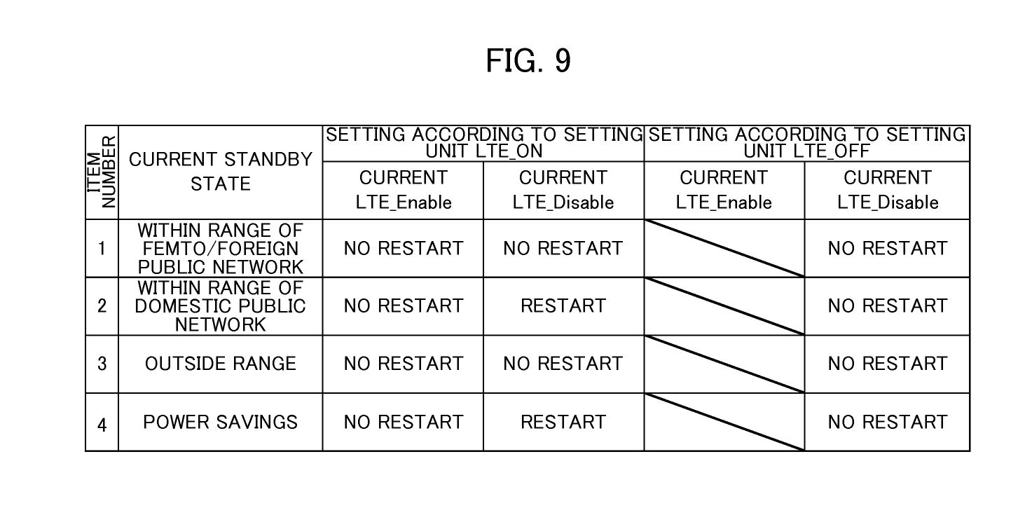

In addition, FIG. 9 shows a schematic diagram of a table referenced by the mobile telephone device 1 upon deciding whether to perform restart (reboot) of a communication system in the case of performing standby of the communication system supporting femtocells according to the operation of the user. The mobile telephone device 1 starts a scan from a communication system having high priority by temporarily entering a disconnection state, in the case of there being a communication system performing standby for communication upon performing restart of the communication system.

The mobile telephone device 1, as shown in FIG. 9, performs restart of the communication system when the current standby state is within range of a domestic public network or a power savings state, in the case of the setting according to the setting unit 43 being LTE_ON (active), and the LTE system being disabled. It should be noted that the mobile telephone device 1 does not perform restart of the communication system in the case of being another state.

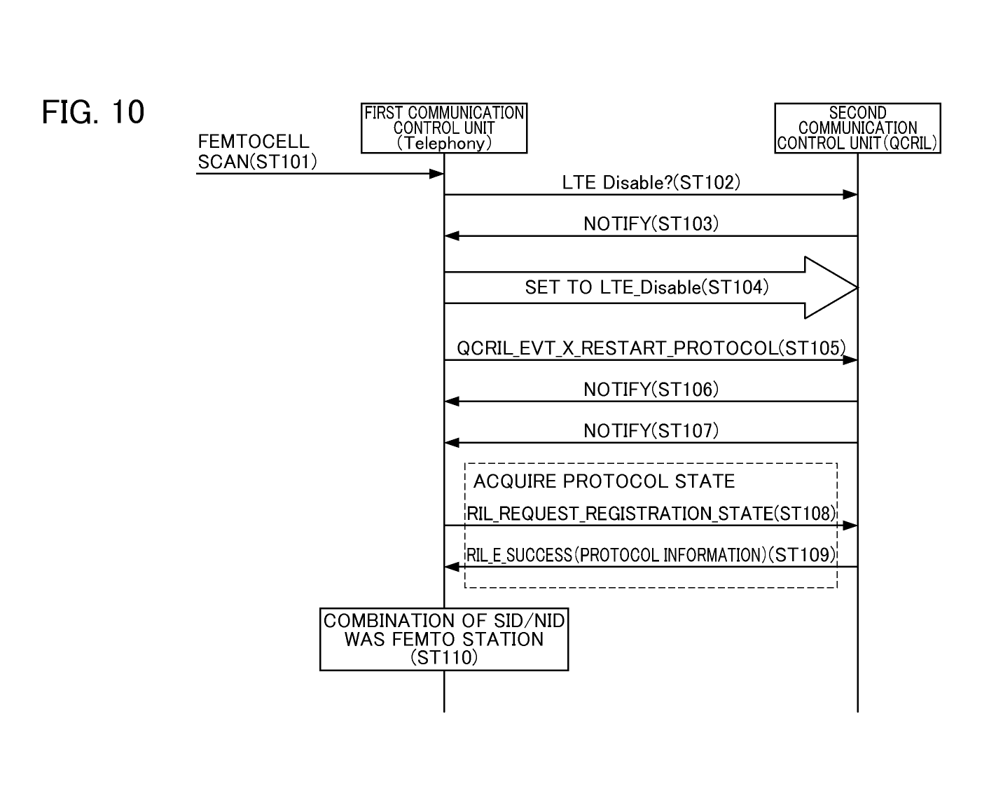

Next, the sequence in a case of the mobile telephone device 1 performing a scan of the communication system supporting femtocells according to the operation of the user, and performing standby of the communication system supporting femtocells will be explained while referencing FIG. 10.

In Step ST101, the first communication control unit 41 accepts a scan start instruction of the communication system supporting femtocells in response to the operation of the user.

In Step ST102, the first communication control unit 41 enquires to the second communication control unit 42 as to whether the LTE system is disabled.

In Step ST103, the second communication control unit 42 notifies that the LTE system is disabled or enabled, in response to the enquiry in Step ST102. In the present example, the second communication control unit 42 notifies that the LTE system is enabled.

In Step ST104, the first communication control unit 41 requests the second communication control unit 42 to disable the LTE system. The second communication control unit 42 changes the setting so that the LTE system becomes disabled in response to this request.

In Step ST105, the first communication control unit 41 controls the second communication control unit 42 so as to perform restart (reboot) of the communication system. More specifically, the first communication control unit 41 sends “QCRIL_EVT_X_RESTART_PROTOCOL” to the second communication control unit 42, and requests restart of the communication system. The modem side starts a scan from the communication system supporting femtocells since the LTE system is disabled.

In Step ST106, the second communication control unit 42 sends the information notified from the modem side to the first communication control unit 41.

In Step ST107, in the case of receiving information about entering within range of a communication system from the modem side, the second communication control unit 42 notifies this fact to the first communication control unit 41.

In Step ST108, the first communication control unit 41 performs acquisition of the protocol state. More specifically, the first communication control unit 41 sends “RIL_REQUEST_REGISTRATION_STATE” to the second communication control unit 42, and requests information of the communication system currently performing standby on the modem side.

In Step ST109, the second communication control unit 42 sends the information notified from the modem side to the first communication control unit 41. More specifically, the second communication control unit 42 sends “RIL_E_SUCCESS” to the first communication control unit 41.

In Step ST110, the first communication control unit 41 determines the classification of the communication system performing standby on the modem side, based on the protocol information received in Step ST109. In the present example, the first communication control unit 41 determines as being the communication system supporting femtocells, based on the SID (Sector ID) and NID (Network ID) included in the protocol information. In this case, the first communication control unit 41 maintains standby of the communication system supporting femtocells.

Consequently, in the case of a search request occurring in response to the operation of the user, since the mobile telephone device 1 performs a search for the other communication systems by excluding the LTE system, which is the first communication system having first priority, even in the case of being within the area of a communication system having high-order priority, and also being within the area of a communication system having low-order priority, it is possible to perform standby for communication by the communication system having low-order priority (e.g., communication system supporting femtocells).

Next, the sequence in a case of the mobile telephone device 1 performing a scan of the communication system supporting femtocells according to the operation of the user, and performing standby within range of a domestic public network will be explained while referencing FIG.

In Step ST111, the first communication control unit 41 accepts a scan start instruction of the communication system supporting femtocells according to the operation of the user.

In Step ST112, the first communication control unit 41 enquires to the second communication control unit 42 as to whether the LTE system is disabled.

In Step ST113, the second communication control unit 42 notifies whether the LTE system is disabled or enabled in response to the enquiry in Step ST112. In the present example, the second communication control unit 42 notifies that the LTE system is enabled.

In Step ST114, the first communication control unit 41 requests to the second communication control unit 42 so as to disable the LTE system. The second communication control unit 42 changes the setting so that the LTE system becomes disabled in response to this request.

In Step ST115, the first communication control unit 41 controls the second communication control unit 42 so as to perform restart (reboot) of the communication system. More specifically, the first communication control unit 41 sends “QCRIL_EVT_X_RESTART_PROTOCOL” to the second communication control unit 42, and requests restart of the communication system. The modem side starts a scan from the communication system supporting femtocells since the LTE system is disabled.

In Step ST116, the second communication control unit 42 sends the information notified from the modem side to the first communication control unit 41. More specifically, the second communication control unit 42 sends “RIL_E_SUCCESS” to the first communication control unit 41.

In Step ST117, in the case of receiving information about entering within range of a communication system from the modem side, the second communication control unit 42 notifies this fact to the first communication control unit 41.

In Step ST118, the first communication control unit 41 performs acquisition of the protocol state. More specifically, the first communication control unit 41 sends “RIL_REQUEST_REGISTRATION_STATE” to the second communication control unit 42, and requests information of the communication system currently performing standby on the modem side.

In Step ST119, the second communication control unit 42 sends the information notified from the modem side to the first communication control unit 41. More specifically, the second communication control unit 42 sends “RIL_E_SUCCESS” to the first communication control unit 41.

In Step ST120, the first communication control unit 41 determines the classification of the communication system performing standby on the modem side, based on the protocol information received in Step ST119. In the present example, the first communication control unit 41 determines as being within range of a domestic public network based on the SID and NID included in the protocol information.

In Step ST121, the first communication control unit 41 requests acquisition of setting information that is set in the setting unit 43 (Settings).

In Step ST122, the setting unit 43 sends the setting information to the first communication control unit 41. The setting unit 43 has setting information of whether to turn ON (active) or turn OFF (inactive) use of the LTE system according to the operation of the user. In the present example, it is established so that the use of the LTE system is ON (active).

In Step ST123, the first communication control unit 41 requests the second communication control unit 42 so as to turn the LTE system from disabled to enabled. The second communication control unit 42 changes the settings so that the LTE system becomes enabled in response to this request.

In Step ST124, the first communication control unit 41 controls the second communication control unit 42 so as to perform restart (reboot) of the communication system. More specifically, the first communication control unit 41 sends “QCRIL_EVT_X_RESTART_PROTOCOL” to the second communication control unit 42, and requests restart of the communication system. The modem side starts a scan from the LTE system.

In Step ST125, the second communication control unit 42 sends the information notified from the modem side to the first communication control unit 41. More specifically, the second communication control unit 42 sends “RIL_E_SUCCESS” to the first communication control unit 41.

By configuring in this way, in the case of performing standby for communication using a network (domestic public network) that is not a communication system supporting femtocells, the mobile telephone device 1 changes the setting so that the LTE system is included among the scan targets and performs a scan by prioritizing the LTE system; therefore, it is possible to effectively utilize the LTE system.

It should be noted that scan in the present embodiment may be reciprocally reworded as search or capture attempt.

### Sixth Embodiment

Hereinafter, a sixth embodiment of the present invention will be explained. It should be noted that, in the present embodiment, the functional configuration of the mobile telephone device 1 differs from the aforementioned embodiments.

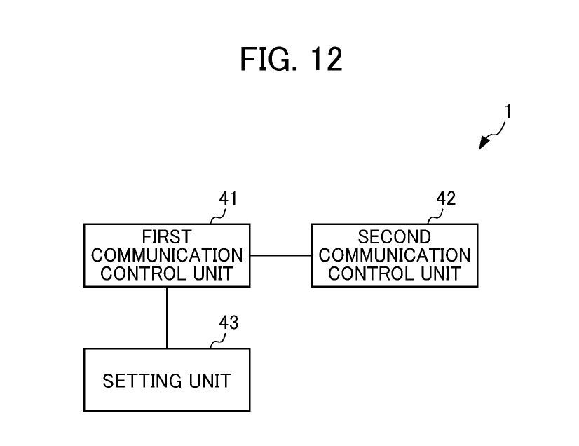

The mobile telephone device 1 of the present embodiment includes the first communication control unit 41 and the second communication control unit 42, as shown in FIG. 12.

Herein, it is assumed that an Android system is built into the mobile telephone device 1 according to the present embodiment. The Android system is configured by a Linux part and a Modem part. A Telephony functional part and a QCRIL functional part are implemented in the Linux part.

With the CDMA system, the Modem part establishes a communication connection following the request from the Telephony functional part implemented in the Linux part.

With the LTE system, the establishment of a PPP session with a 2G/3G terminal such as a conventional CDMA system, GSM, UMTS or the like, and the sequence of acquiring IP addresses differ, and the establishment processing of a communication connection is performed asynchronously by the Modem part and Linux part.

The Telephony functional part corresponds to the first communication control unit 41. The QCRIL functional part corresponds to the second communication control unit 42.

The second communication control unit 42 starts the search prioritizing the first communication system, upon searching for communication systems. First communication system, for example, is a communication system of the LTE standard (LTE system).

As the result of a search, in the case of performing standby for communication by the second communication system, the first communication control unit 41 controls the second communication control unit 42 so as to exclude the first communication system from the next search targets.

By configuring in this way, in the case of performing a search including the first communication system having high priority, a result of which the first communication system cannot be captured, and performing standby for communication by way of the second communication system, the mobile telephone device 1 excludes the first communication system from the targets of the next search; therefore, it is possible to suppress unnecessary searches, and perform standby for communication with a communication system having low-order priority.

The first communication control unit 41 may be a configuration that controls the second communication control unit 42 so that the first communication system is included among the targets of the next search, in the case of having controlled the second communication control unit 42 so as to exclude the first communication system from the search targets, and being an outside range state or performing standby for communication by way of a third communication system.

It should be noted that the second communication system may be a communication system constituted by a base station having a smaller coverage area than a microcell base station. For example, the second communication system is a communication system constituted by femtocell base stations (communication system supporting femtocells). It should be noted that the constituting base stations are not limited to femtocells, and may be nanocells or picocells.

In addition, the third communication system may be a communication system constituted by microcell base stations.

It was assumed that the mobile telephone device 1 performs a search excluding the first communication system having first priority, then captures the second communication system having second priority, and performs standby for communication by way of the second communication system. However, the mobile telephone device 1 failed in the search of the second communication system, and was an outside range state or performed standby for communication by way of the third communication system.

In such a situation, the mobile telephone device 1 establishes so that the first communication system is included among the next search targets; therefore, in a case of departing from the assumption, since the search of the first communication system is performed, it is possible to perform standby for communication by way of the communication system having first priority, as normal.

The mobile telephone device 1 includes the setting unit 43 as shown in FIG. 12.

The first communication control unit 41 may be a configuration that controls the second communication control unit 42 so that the first communication system is included among the search targets, on the condition of being set by the setting unit 43 so that the first communication system is included among the search targets.

The setting unit 43 has setting information of whether to turn ON (active) or turn OFF (inactive) use of the LTE system according to the operation of the user.

It should be noted that setting by the setting unit 43 so that the first communication system is included among the search targets indicates use of the LTE system being set to ON (active).

Consequently, since the mobile telephone device 1 temporarily makes the first communication system that had been excluded from the search targets to be included among the search targets upon the condition of use of the LTE system being set to ON (active) according to the operation of the user, it is possible to perform standby for communication with a communication system having low-order priority under a fixed condition, while reflecting the intentions of the user.

The first communication control unit 41 may be a configuration that controls the second communication control unit 42 so that the first communication system is included among the search targets, in the case of performing standby for communication with a communication system other than the communication system supporting femtocells according to the second communication control unit 42.

This is assuming a case of the mobile telephone device 1 having performed a search by excluding the first communication system from the search targets, but not being able to capture the second communication system.

In such a case, the mobile telephone device 1 establishes so as to be able to standby for communication by the first communication system, by way of returning back to the settings with the first communication system as the first-order communication system, as normal.

By being configured in this way, the mobile telephone device 1, in the case of performing a search according to the operation of the user, and performing standby for communication by a communication system other than the communication system supporting femtocells, controls the second communication control unit 42 so that the first communication system (LTE system) is included among the search targets; therefore, when it is not possible to use the communication system supporting femtocells, it is possible to achieve use of the LTE system.

The first communication control unit 41 may be a configuration that controls the second communication control unit 42 so that the first communication system is included among the search targets, in the case of transitioning to a power saving state in which standby for communication is not possible for any communication system, as a result of a search.

This is assuming a case of the mobile telephone device 1 having performed a search by excluding the first communication system from the search targets, but including the second communication system and not being able to capture all communication systems.

In such a case, the mobile telephone device 1 establishes so as to be able to standby for communication by the first communication system, by way of returning back to the settings with the first communication system as the first-order communication system, as normal.

By being configured in this way, in a case of performing a search according to the operation of the user, and not being able to capture all of the communication systems including the communication system supporting femtocells, since the mobile telephone device 1 controls the second communication control unit 42 so that the first communication system (LTE system) is included among the search targets, it is possible to achieve use of the LTE system.

The first communication control unit 41 may be a configuration that controls the second communication control unit 42 so as to start a search from the first communication system, after controlling the second communication control unit 42 so that the first communication system is included among the search targets.

According to such a configuration, for example, in a case of performing searching according to the operation of the user, and performing standby for communication by a communication system other than the communication system supporting femtocells, the mobile telephone device 1 starts a search from the first communication system when changing the settings so that the first communication system (LTE system) is included among the search targets; therefore, it is possible to achieve use of the LTE system actively.

### Examples

Herein, the processing when the mobile telephone device 1 stands by with the communication system supporting femtocells when outside range of the LTE system will be explained.

In the case of performing standby of the communication system supporting femtocells automatically when outside range of the LTE system, the mobile telephone device 1 disables the LTE system. In addition, the mobile telephone device 1 enables the LTE system when disconnecting the communication system supporting femtocells, when in power savings, or when public network standby. To enable the LTE system indicates including the LTE system among search targets, and to disable the LTE system indicates excluding the LTE system from the search targets.

It should be noted that, due to prioritizing setting of the mobile telephone device 1, in the case of the LTE system being turned OFF (inactive) according to the settings, the mobile telephone device 1 will not enable the LTE system.

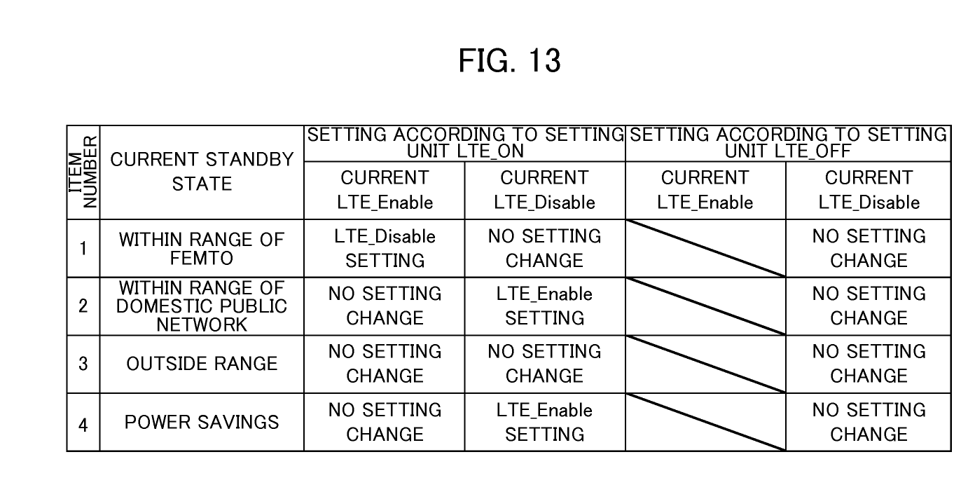

In addition, FIG. 13 shows a schematic diagram of a table referenced by the mobile telephone device 1 when deciding whether to change the setting of the LTE system in the case of performing standby of the communication system supporting femtocells automatically when outside range of the LTE system.

As shown in FIG. 13, the mobile telephone device 1 sets the LTE system to disabled in the case of the current standby state being the communication system supporting femtocells, the setting according to the setting unit 43 being LTE_ON (active), and the LTE system being enabled. In other words, the mobile telephone device 1 changes the setting to a state in which the LTE system cannot be used.

In addition, as shown in FIG. 13, the mobile telephone device 1 sets the LTE system to enabled in the case of when the current standby state is within range of a domestic public network or the power savings state, the setting according to the setting unit 43 being LTE_ON (active) and the LTE system being disabled. In other words, the mobile telephone device 1 changes the setting to a state in which the LTE system can be used. It should be noted that the mobile telephone device 1 does not perform a change in the setting in the case of being another state.

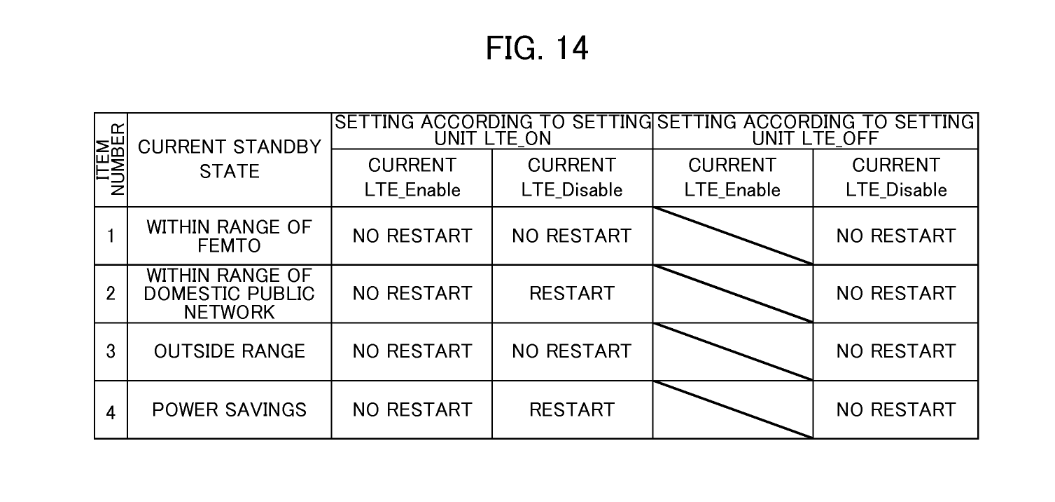

In addition, FIG. 14 shows a schematic diagram of a table referenced by the mobile telephone device 1 when deciding whether to perform restart (restart) of the communication system. The mobile telephone device 1 starts a scan from a communication system having high priority by temporarily entering a disconnection state, in the case of there being a communication system performing standby of communication upon performing restart of the communication system.

As shown in FIG. 14, the mobile telephone device 1 performs restart of the communication system in the case of when the current standby state is within range of domestic public network or a power savings state, the setting according to the setting unit 43 being LTE_ON (active), and the LTE system being disabled. It should be noted that the mobile telephone device 1 does not perform restart of the communication system in a case of being another state.

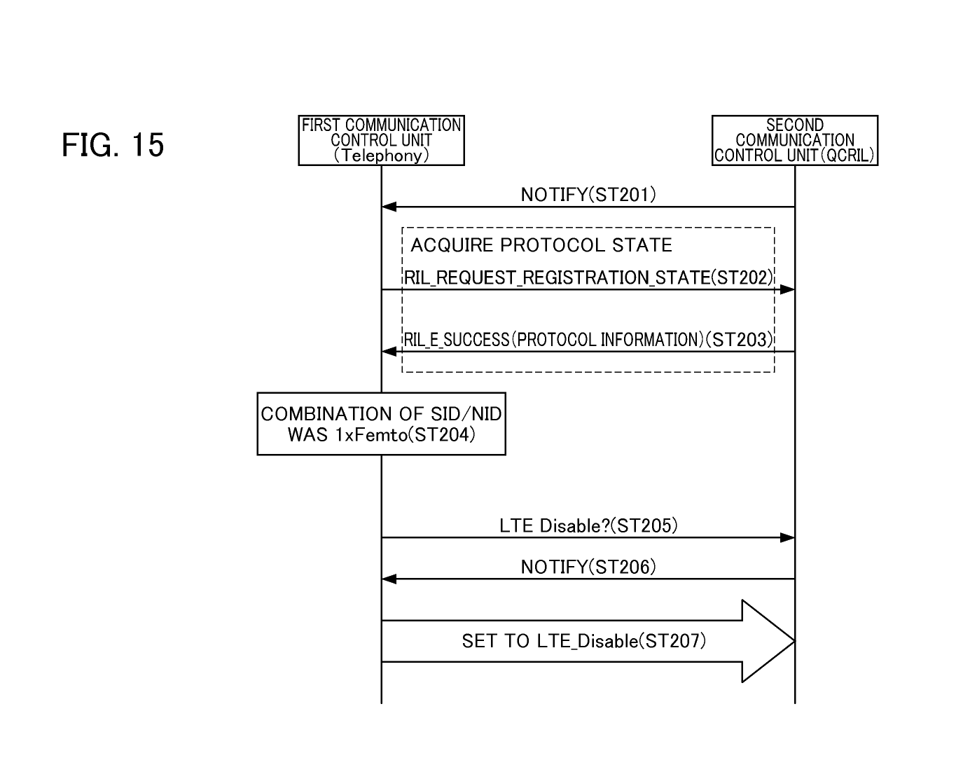

Next, the sequence in a case of the mobile telephone device 1 performing standby of the communication system supporting femtocells when outside range of the LTE system will be explained while referencing FIG. 15.

In Step ST201, in the case of receiving information about entering within range of a communication system from the modem side, the second communication control unit 42 notifies of this fact to the first communication control unit 41.

In Step ST202, the first communication control unit 41 performs acquisition of the protocol state. More specifically, the first communication control unit 41 sends “RIL_REQUEST_REGISTRATION_STATE” to the second communication control unit 42, and requests information of the communication system currently performing standby on the modem side.

In Step ST203, the second communication control unit 42 sends the information notified from the modem side to the first communication control unit 41. More specifically, the second communication control unit 42 sends “RIL_E_SUCCESS” to the first communication control unit 41.

In Step ST204, the first communication control unit 41 determines the classification of the communication system performing standby on the modem side, based on the protocol information received in Step ST203. In the present example, the first communication control unit 41 determines as being the communication system supporting femtocells, based on the SID and NID included in the protocol information.

In Step ST205, the first communication control unit 41 enquires to the second communication control unit 42 as to whether the LTE system is disabled.

In Step ST206, the second communication control unit 42 notifies the first communication control unit 41 that the LTE system is disabled or enabled in response to the enquiry in Step ST205. In the present example, the second communication control unit 42 notifies that the LTE system is enabled.

In Step ST207, the first communication control unit 41 requests to the second communication control unit 42 so as to make the LTE system disabled. The second communication control unit 42 changes the setting so that the LTE system becomes disabled in response to this request.

Consequently, in the case of a search request occurring in response to the operation of the user, since the mobile telephone device 1 performs searching for the other communication system by excluding the LTE system, which is the first communication system having first priority, even in the case of being within the area of a communication system having high-order priority, and also being within the area of a communication system having low-order priority, it is possible to perform standby for communication by the communication system having low-order priority (e.g., communication system supporting femtocells).

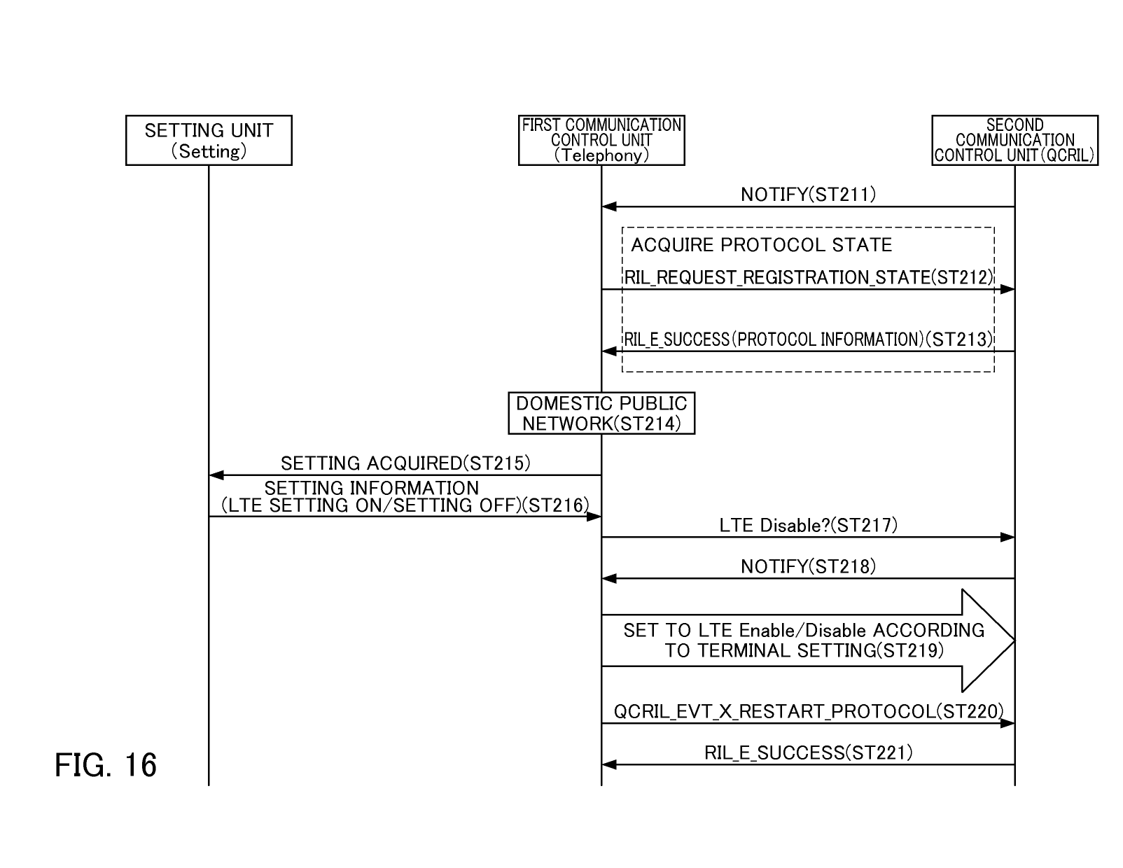

Next, the sequence in a case of the mobile telephone device 1 performing standby within range of a domestic public network will be explained while referencing FIG. 16.

In Step ST211, in the case of receiving information about entering within range of a communication system from the modem side, the second communication control unit 42 notifies of this fact to the first communication control unit 41.

In Step ST212, the first communication control unit 41 performs acquisition of the protocol state. More specifically, the first communication control unit 41 sends “RIL_REQUEST_REGISTRATION_STATE” to the second communication control unit 42, and requests information of the communication system currently performing standby on the modem side.

In Step ST213, the second communication control unit 42 sends the information notified from the modem side to the first communication control unit 41. More specifically, the second communication control unit 42 sends “RIL_E_SUCCESS” to the first communication control unit 41.

In Step ST214, the first communication control unit 41 determines the classification of the communication system performing standby on the modem side, based on the protocol information received in Step ST213. In the present example, the first communication control unit 41 determines as being within range of a domestic public network, based on the SID and NID included in the protocol information. It should be noted that the communication system supporting femtocells is not included in the domestic public network.

In Step ST215, the first communication control unit 41 requests the acquisition of setting information that is set in the setting unit 43 (setting).

In Step ST216, the setting unit 43 sends the setting information to the first communication control unit 41. The setting unit 43 has setting information of whether to turn ON (active) or turn OFF (inactive) use of the LTE system according to the operation of the user. In the present example, it is established so that the use of the LTE system is ON (active).

In Step ST217, the first communication control unit 41 enquires to the second communication control unit 42 as to whether the LTE system is disabled.

In Step ST218, the second communication control unit 42 notifies to the first communication control unit 41 as to whether the LTE system is disabled or enabled, in response to the enquiry in Step ST217. In the present example, the second communication control unit 42 notifies that the LTE system is enabled.

In Step ST219, the first communication control unit 41 requests to the second communication control unit 42 so as to make the LTE system disabled. The second communication control unit 42 changes the setting so that the LTE system becomes disabled in response to this request.

In Step ST220, the first communication control unit 41 controls the second communication control unit 42 so as to perform restart (reboot) of the communication system. More specifically, the first communication control unit 41 sends “QCRIL_EVT_X_RESTART_PROTOCOL” to the second communication control unit 42, and requests restart of the communication system. The modem side starts a scan from the LTE system.

In Step ST221, the second communication control unit 42 sends the information notified from the modem side to the first communication control unit 41. More specifically, the second communication control unit 42 sends “RIL_E_SUCCESS” to the first communication control unit 41.

By configuring in this way, in the case of performing standby for communication using a network (domestic public network) that is not a communication system supporting femtocells, the mobile telephone device 1 can changes the setting so that the LTE system is included among the scan targets and performs scanning by prioritizing the LTE system; therefore, it is possible to effectively utilize the LTE system.

Communication system supporting femtocells is the matter of a communication system that installs a small-scale cell in each household as a dead-zone countermeasure in a radio area such as a high-rise apartment building, and performs voice and data communication using the BB (Broadband) line, etc. of the users.

The femtocell is realized by ultracompact base stations installed in a household or small office. The ultracompact base stations are connected with fixed lines (telephone lines) connecting to land-line phones in a household, optical fiber, CATV cable, or the like, and generate radio waves that can be received by the mobile telephone device 1.

The radio waves generated by the ultracompact base station are similar to a normal external base station arranged outdoors, except for the output level. Therefore, the mobile telephone device 1 can perform voice and data communication with the ultracompact base station in the same sequence as the case of performing voice and data communication with an external base station.

In addition, in order to realize the CSFB (Circuit Switched Fallback) function, the external base station must notify which area of the CDMA system that the mobile telephone device 1 in standby by the LTE system is physically in. CSFB is circuit switching fallback, and is a plan for switching the data communications network (e.g., LTE system) to circuit switching such as the 3G system.

Herein, processing upon switching to the CDMA system by CSFB will be explained, in the case of there being an incoming call of voice communication to the mobile telephone device 1 performing standby by the LTE system.

In the case of there being an incoming call to the mobile telephone device 1, based on mapping data of the area between the LTE system and CDMA system, the external base station specifies the area of the CDMA system to which the mobile telephone device 1 currently belongs, and notifies the mobile telephone device 1 using the LTE system so as to do CSFB in the area of the specified CDMA system.

The mobile telephone device 1 switches from the LTE system to the CDMA system in response to this notification, and performs registration at the external base station.

The external base station updates position registration information according to this registration, and notifies of the incoming call by way of the CDMA system to the mobile telephone device 1.

The mobile telephone device 1 performs predetermined informing according to this notification. The mobile telephone device 1 initiates a telephone call in response to an operation by the user.

In the case of installing femtocells in a dead-zone of a radio area such as a high-rise apartment, the voice protocol (CDMA system) of the public network often is outside range.

In other words, in such an area, in the case of the mobile telephone device 1 performing standby by the LTE system, when trying to perform the aforementioned such CSFB, since the external base station does not have mapping data of the LTE system and femtocells, CSFB fails, and the mobile telephone device 1 no longer can perform sending/receiving of voice communication.

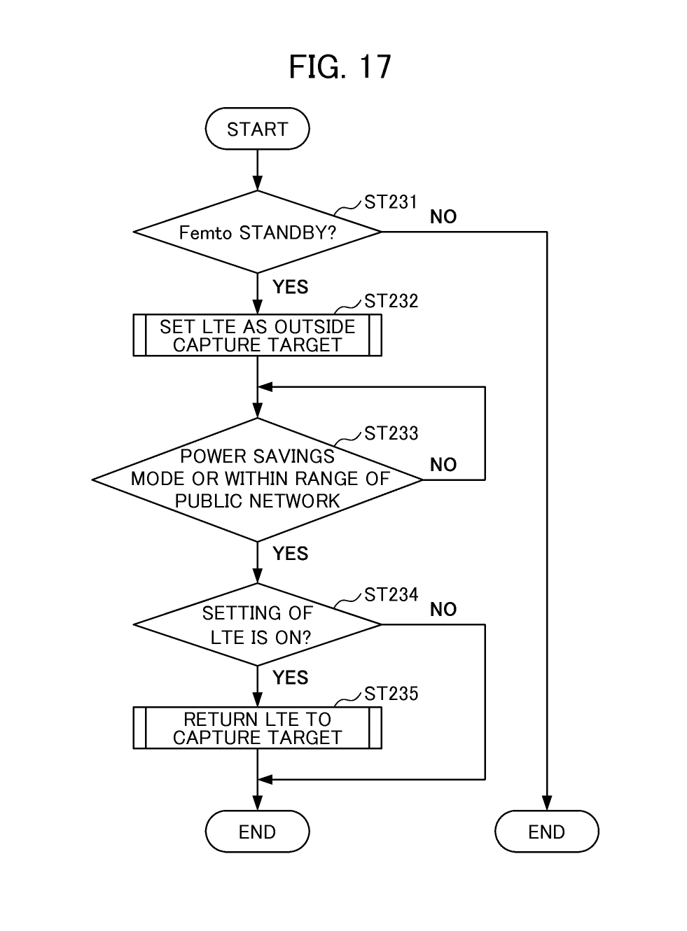

Herein, the processing of turning OFF the LTE system in the case of the mobile telephone device 1 transitioning to the area of a femtocell, and turning ON the LTE system according to the setting by the user in the case such as transitioning, etc. outside range of the area of the femtocell will be explained while referencing the flowchart of FIG. 17.

In Step ST231, the first communication control unit 41 determines whether or not currently standby of the communication system supporting femtocells. In the case of determining as being standby of the communication system supporting femtocells, the processing advances to Step ST232, and in the case of determining as not being standby of the communication system supporting femtocells, the processing ends.

In Step ST232, the first communication control unit 41 controls so that the LTE system is outside the capture targets. In other words, the first communication control unit 41 controls so that the LTE system is not included among the targets searching for communication systems. It should be noted that even if the setting of the LTE system is ON (active) according to the setting unit 43, the setting of the LTE system is forcibly turned OFF (inactive).

In Step ST233, the first communication control unit 41 determines whether being in power savings mode or within range of a domestic public network. In the case of determining as being in the power savings mode or within range of a domestic public network (YES), the processing advances to Step ST234, and in the case of determining as not being in the power savings mode or within range of a domestic public network (NO), the present processes are repeated.

In Step ST234, the first communication control unit 41 determines whether the setting of the LTE system is ON (active). In the case of determining that the setting of the LTE system is ON (active) (YES), the processing advances to Step ST235, and in the case of determining that the setting of the LTE system is not ON (active) (NO), i.e. in the case of the setting of the LTE system being OFF (inactive), the processing ends.

In Step ST235, the first communication control unit 41 controls so that the LTE system is included among the capture targets. In other words, the first communication control unit 41 controls so as to return the setting of the LTE system that was forcibly turned OFF (inactive) in the process of Step ST232 back to the original state (state of ON (active)).

By configuring in this way, the mobile telephone device 1 forcibly turns OFF (inactive) the setting of the LTE system in the case of entering within range of the area of a femtocell and performing standby by the communication system supporting femtocells, and controls so that the setting of the LTE system follows the setting of the setting unit 43, in the case of moving outside range of the area of the femtocell. Therefore, since the mobile telephone device 1 limits the use of the LTE system within range of the area of a femtocell, it is possible to favorably execute sending and receiving of voice communication.

In addition, the communication devices according to the first to sixth embodiments are not limited to the mobile telephone device 1. The present invention is applicable to various devices such as PHS (Personal Handyphone System), PDA (Personal Digital Assistant), game consoles, navigation devices, personal computers, and communication-dedicated modules specializing for communication function.

In addition, although the configuration and operation of a mobile telephone device are mainly explained in the aforementioned first to sixth embodiments, the present invention is not limited thereto, and may be configured to include the respective constituent elements as a communication method and program for performing standby for communication by a communication system having low-order priority under fixed conditions.

Furthermore, the present invention may be implemented by recording a program for realizing the functions of a mobile telephone device into a computer-readable recording medium, causing the program recorded on this recording medium to be read into a computer system and executed.

“Computer system” referred to herein is defined as including the OS and hardware such as peripheral devices. In addition, “computer-readable recording medium” refers to portable media such as a flexible disk, magneto-optical disk, ROM and CD-ROM, and a storage device such as a hard disk built into the computer system.

Furthermore, the “computer-readable recording medium” may include matters retaining a program over a short time or dynamically as in a communication line in the case of sending a program via a network such as the Internet and communication lines such as telephone lines, and matters retaining a program for a limited time, as in volatile memory inside of a computer system serving as a server or client in this case. In addition, the above-mentioned program may be for realizing a part of the aforementioned functions, or may further be able to realize the aforementioned functions in combination with a program already recorded in the computer system.

### Seventh Embodiment

A seventh embodiment of the present invention will be explained in detail while referencing the drawings. Hereinafter, a smartphone will be explained as an example of a communication device.

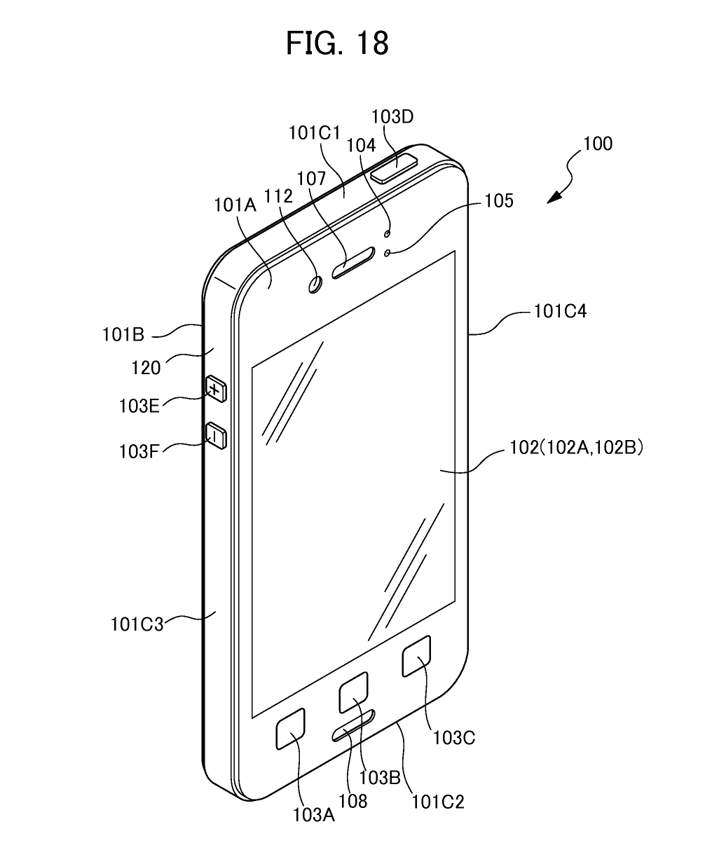

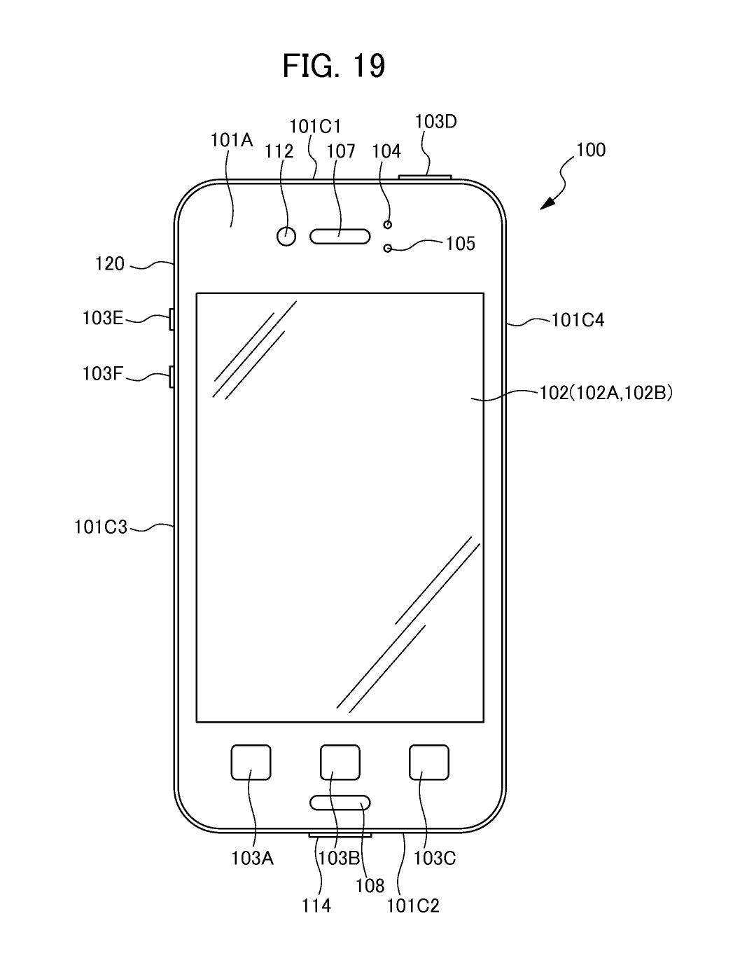

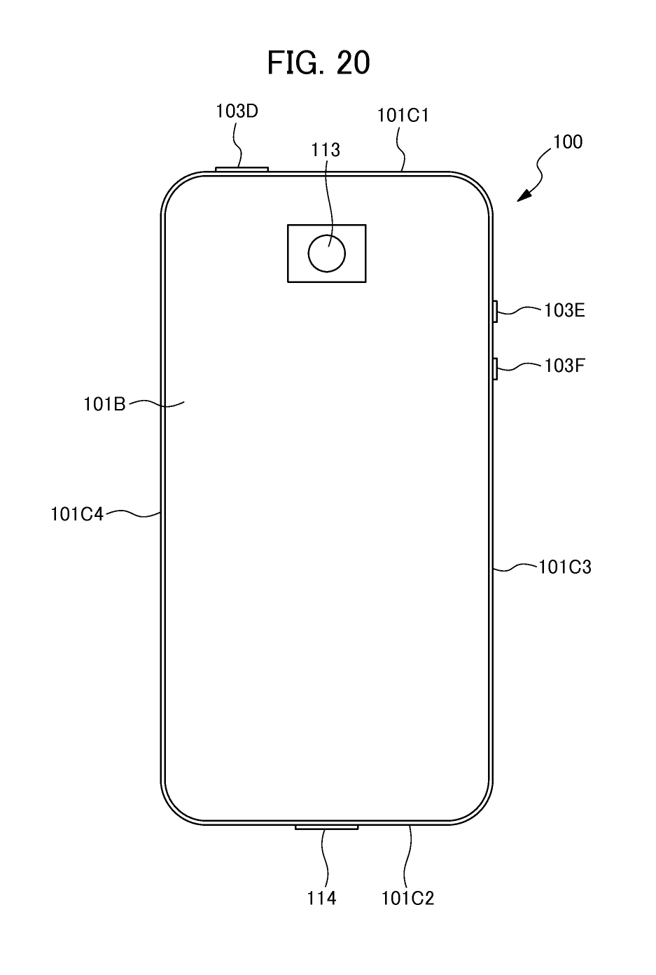

Descriptions are provided for the external appearance of a smartphone 100 according to the embodiment while referencing FIGS. 18 to 20. As shown in FIGS. 18 to 20, the smartphone 100 has a housing 120. The housing 120 has a front face 101A, a back face 101B, and side faces 101C1 to 101C4. The front face 101A is a front face of the housing 120. The back face 101B is a back face of the housing 120. The side faces 101C1 to 101C4 are side faces that connect the front face 101A and the back face 101B. Hereinafter, the side faces 101C1 to 101C4 may be collectively referred to as a side face 101C without specifying which face.

On the front face 101A, the smartphone 100 has a touch-screen display 102, buttons 103A to 103C, an illuminance sensor 104, a proximity sensor 105, a receiver 107, a microphone 108, and a camera 112. The smartphone 100 has a camera 113 in the back face 101B. The smartphone 100 has buttons 103D to 103F and an external interface 114 in the side face 101C. In the following descriptions, the buttons 103A to 103F may be collectively referred to as a button 103 without specifying which button.

The touch-screen display 102 has a display 102A and a touch screen 102B. The display 102A includes a display device such as a liquid crystal display, an organic electro-luminescence panel (Organic EL Panel), or an inorganic electro-luminescence panel (Inorganic EL Panel). The display 102A displays characters, images, symbols, graphics or the like.

The touch screen 102B detects a touch by a finger, a stylus pen or the like to the touch-screen display 102. The touch screen 102B detects a position where a plurality of fingers, the stylus pen or the like touch the touch-screen display 102.

A detection method for the touch screen 102B may be any method such as a capacitive sensing method, a resistor film method, a surface acoustic wave method (or an ultrasonic sensing method), an infrared ray method, an electromagnetic induction method, and a load detection method. In the following, for the purpose of simplifying the explanation, the fingers, the stylus pen or the like for which touching to the touch-screen display 102 is detected by the touch screen 102B, may be simply referred to as a “finger”.

The smartphone 100 distinguishes types of gestures, based on a touch, a touch position(s), a touching period of time, or the number of times touching, as detected by the touch screen 102B. The gesture is an operation that is performed on the touch-screen display 102. Gestures that are distinguished by the smartphone 100 include a touch, a long touch, a release, a swipe, a tap, a double tap, a long tap, a drag, a flick, a pinch-in, a pinch-out, and the like.

The touch is a gesture of a finger that touches the touch-screen display 102 (for example, a surface thereof). The smartphone 100 distinguishes the gesture of a finger touching the touch-screen display 102 as a touch. The long touch is a gesture of a finger touching the touch-screen display 102 for more than a certain period of time. The smartphone 100 distinguishes the gesture of a finger touching the touch-screen display 102 for more than a certain period of time as a long touch.

The release is a gesture of a finger being released from the touch-screen display 102. The smartphone 100 distinguishes the gesture of a finger being released from the touch-screen display 102 as a release. The swipe is a gesture of a finger moving while touching the touch-screen display 102. The smartphone 100 distinguishes the gesture of a finger moving while touching the touch-screen display 102 as a swipe.

The tap is a consecutive gesture of touch and release. The smartphone 100 distinguishes the consecutive gesture of touch and release as a tap. The double tap is a gesture of repeating a consecutive gesture of touch and release two times. The smartphone 100 distinguishes the gesture of repeating a consecutive gesture of touch and release two times as a double tap.

The long tap is a consecutive gesture of a long touch and release. The smartphone 100 distinguishes the consecutive gesture of a long touch and release as a long tap. The drag is a gesture of swiping from a starting point where a movable object is displayed. The smartphone 100 distinguishes the gesture of swiping from a starting point where a movable object is displayed as a drag.

The flick is a consecutive gesture of touch and release of a finger moving at a high-speed in one direction. The smartphone 100 distinguishes the gesture of touch and release of a finger moving at a high-speed in one direction as a flick. The flick includes: an upward flick of a finger moving in an upward direction on the screen; a downward flick of a finger moving in a downward direction on the screen; a rightward flick of a finger moving in a rightward direction on the screen; a leftward flick of a finger moving in a leftward direction on the screen; and the like.

The pinch-in is a gesture of a plurality of fingers swiping in mutually approaching directions. The smartphone 100 distinguishes the gesture of a plurality of fingers swiping in mutually approaching directions as a pinch-in. The pinch-out is a gesture of a plurality of fingers swiping in mutually receding directions. The smartphone 100 distinguishes the gesture of a plurality of fingers swiping in mutually receding directions as a pinch-out.

The smartphone 100 is operated in accordance with these gestures that are distinguished via the touch screen 102B. Therefore, intuitive and easy-to-use operability is achieved for a user. An operation, which is performed by the smartphone 100 in accordance with a gesture thus distinguished, is different depending on the screen that is displayed on the touch-screen display 102.

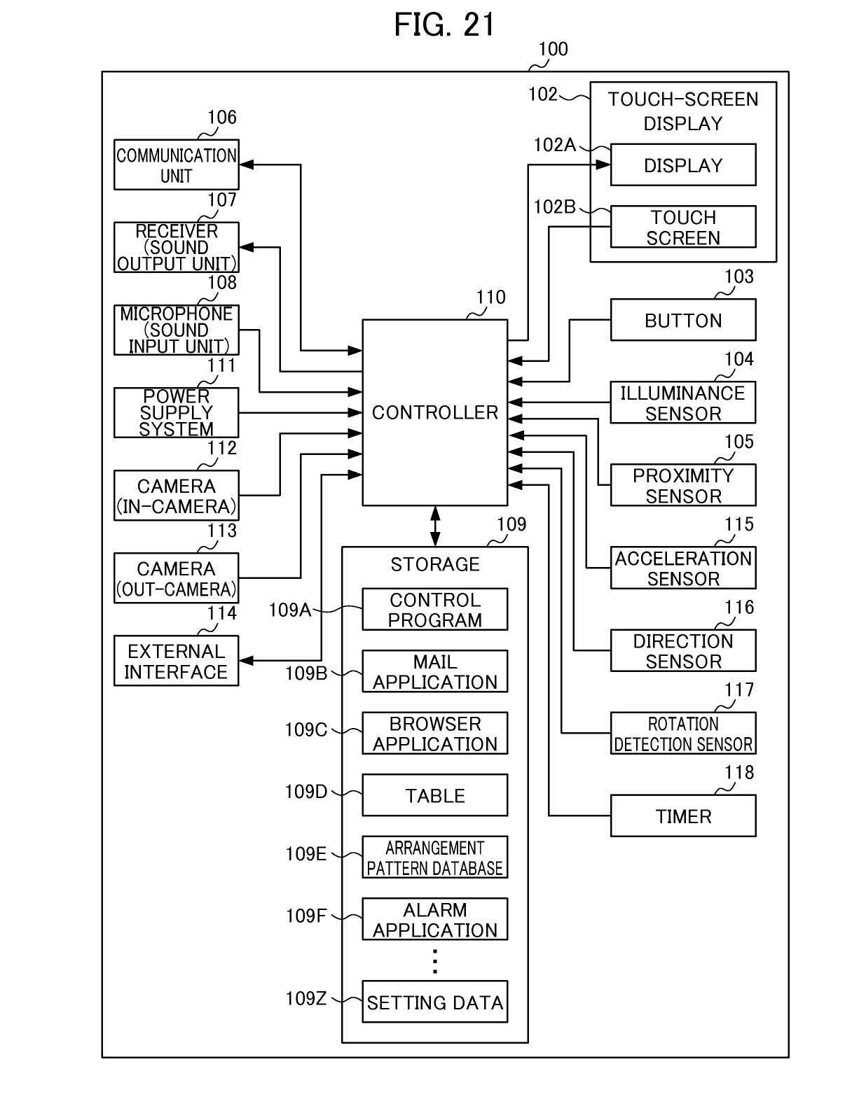

FIG. 21 is a block diagram showing an arrangement of the smartphone 100. The smartphone 100 has the touch-screen display 102, the button 103, the illuminance sensor 104, the proximity sensor 105, a communication unit 106, the receiver 107, the microphone 108, storage 109, a controller 110, cameras 112 and 113, an external interface 114, an acceleration sensor 115, a direction sensor 116, and a rotation detection sensor 117.

As described above, the touch-screen display 102 has the display 102A and the touch screen 102B. The display 102A displays characters, images, symbols, graphics or the like. The touch screen 102B detects a gesture.

The button 103 is operated by the user. The button 103 has the buttons 103A to 103F. The controller 110 collaborates with the button 103 to detect an operation of the button 103. The operation of the button 103 is, for example, a click, a double click, a push, and a multi-push.

For example, the buttons 103A to 103C are a home button, a back button or a menu button. For example, the button 103D is a power on/off button of the smartphone 100. The button 103D may also serve as a sleep/wake-up button. For example, the buttons 103E and 103F are volume buttons.

The illuminance sensor 104 detects illuminance. For example, the illuminance is intensity, brightness, brilliance, etc. of light. For example, the illuminance sensor 104 is used for adjusting the brilliance of the display 102A.

The proximity sensor 105 detects the presence of a proximate object in a contactless manner. The proximity sensor 105 detects, for example, a face being brought close to the touch-screen display 102.

The communication unit 106 performs wireless communication. Communication schemes implemented by the communication unit 106 are wireless communication schemes. For example, the wireless communication schemes include cellular phone communication schemes such as 2G, 3G and 4G. For example, the cellular phone communication standards include LTE (Long Term Evolution), W-CDMA, CDMA2000 (CDMA1x, CDMA1x-EVDO), PDC, GSM, PHS (Personal Handy-phone System), etc. For example, the wireless communication standards include WiMAX (Worldwide Interoperability for Microwave Access), IEEE 802.11, Bluetooth, IrDA, NFC (Near Field Communication), etc. Communication unit 106 may support one or more of the communication standards described above.

When a sound signal is transmitted from the controller 110, the receiver 107 outputs the sound signal as sound. The microphone 108 converts sound such as the user's voice into a sound signal, and transmits the sound signal to the controller 110. The smartphone 100 may further have a speaker(s) in addition to the receiver 107. The smartphone 100 may further have a speaker(s) in place of the receiver 107.

The storage 109 stores programs and data. The storage 109 is also utilized as a working area for temporarily storing processing results of the controller 110. The storage 109 may include an arbitrary storage device such as a semi-conductor storage device and a magnetic storage device. The storage 109 may include several types of storage devices. The storage 109 may include a combination of a portable storage medium such as a memory card with a reader for the storage medium.

The programs stored in the storage 109 include: applications that are executed in the foreground or the background; and a control program that assists operations of the applications. For example, an application causes the display 102A to display a predetermined screen, and causes the controller 110 to execute processing in accordance with a gesture detected by the touch screen 102B. The control program is, for example, an OS. The applications and the control program may be installed in the storage 109 via wireless communication by the communication unit 106 or via a storage medium.

The storage 109 stores, for example, a control program 109A, a mail application 109B, a browser application 109C, and setting data 109Z. The mail application 109B provides electric mail functions of creating, transmitting, receiving and displaying electric mail. The browser application 109C provides a web browsing function of displaying web pages. A table 109D stores various tables such as a key assignment table. An arrangement pattern database 109E stores patterns of arrangement such as arrangement of icons displayed on the display 102A. The setting data 109Z provides various set-up functions regarding operations of the smartphone 100.

The control program 109A provides functions regarding a variety of controls for operating the smartphone 100. For example, the control program 109A implements a telephone call function by controlling the communication unit 106, the receiver 107, the microphone 108, etc. The functions provided by the control program 109A include functions of executing a variety of controls such as changing the information displayed on the display 102A in accordance with a gesture detected via the touch screen 102B. The functions provided by the control program 109A may be utilized in combination with functions provided by other programs such as the mail application 109B.

The controller 110 is, for example, a CPU (Central Processing Unit). The controller 110 may be an integrated circuit such as an SoC (System-on-a-chip) that integrates other constituent elements such as the communication unit 106. The controller 110 comprehensively controls the operations of the smartphone 100 to implement various functions.

More specifically, the controller 110 implements various functions by referring to data stored in the storage 109 as necessary, executing instructions included in a program stored in the storage 109, and controlling the display 102A, the communication unit 106, etc. The controller 110 may change the control in accordance with a result of detection by various detecting units such as the touch screen 102B, the button 103 and the acceleration sensor 115.

For example, the controller 110 executes the control program 109A to execute a variety of control such as changing the information displayed on the display 102A in accordance with a gesture detected via the touch screen 102B.

The camera 112 is an in-camera that photographs an object from a side of the front face 101A. The camera 113 is an out-camera that photographs an object from a side of the back face 101B.

The external interface 114 is a terminal to which another device is connected. The external interface 114 may be a universal terminal such as USB (Universal Serial Bus), HDMI (High-Definition Multimedia Interface), Light Peak (Thunderbolt), and an earpiece-microphone connector. The external interface 114 may be a terminal designed for exclusive use, such as a Dock connector. A device that is connected to the external interface 114 includes, for example, external storage, a speaker, and a communication device.

The acceleration sensor 115 detects a direction and a level of acceleration that acts on the smartphone 100. The direction sensor 116 detects an orientation of geomagnetism. The rotation detection sensor 117 detects rotation of the smartphone 100. Results of such detection by the acceleration sensor 115, the direction sensor 116 and the rotation detection sensor 117 are utilized in combination to detect change in the position and posture of the smartphone 100.

Hereinafter, the smartphone 100 is established as supporting the LTE system and CDMA system. The LTE system (first communication system) is a communication system not supporting voice calls by way of a circuit switching system, and the CDMA system (second communication system) is a communication system that supports voice calls by way of a circuit switching system.

The smartphone 100 is established to perform handover to the CDMA system by way of the CS fallback function in the case of there being a voice outgoing call or incoming call during standby for communication by the LTE system. It should be noted that CDMA system referred to herein may indicate the matter of a CDMA1x system.

It should be noted that the standby destination in the CDMA system includes the small-scale cells called femtocells, in addition to typical cells (macrocell, microcell, nanocell, picocell, or the like) that can serve as the handover destination by way of CS fallback.

The femtocell has a narrower communicable area than base stations such as typical macrocells and microcells (for example, radius up to several tens of meters). The communication system using this femtocell (communication system supporting femtocells) is a system that performs voice or data communication by installing a plurality of small base stations as a radio wave dead-zone countermeasure in high-rise apartment buildings, shopping centers, etc., and using a broadband line, or the like.

The base station of the femtocell connects with the Internet via a fixed line such as telephone line, optical fiber or CATV cable, and emits radio waves that can be captured by the communication device within the cell area. The emitted radio waves are basically similar to the base stations constituting typical macrocells, or the like other than the output strength; therefore, the communication device can communicate with the base station of the femtocell similarly to the base stations such as a typical macrocell.

In the present embodiment, the LTE system that is the public network and the communication system supporting femtocells are established as not having mapping done for conducting CS feedback. In other words, in the case of the non-femtocell voice protocol, which is the public network of the CDMA system, being outside range, since the communication device cannot handover to non-femtocell by CS fallback, it will fail in voice outgoing calls/incoming calls, even if a femtocell were within range.

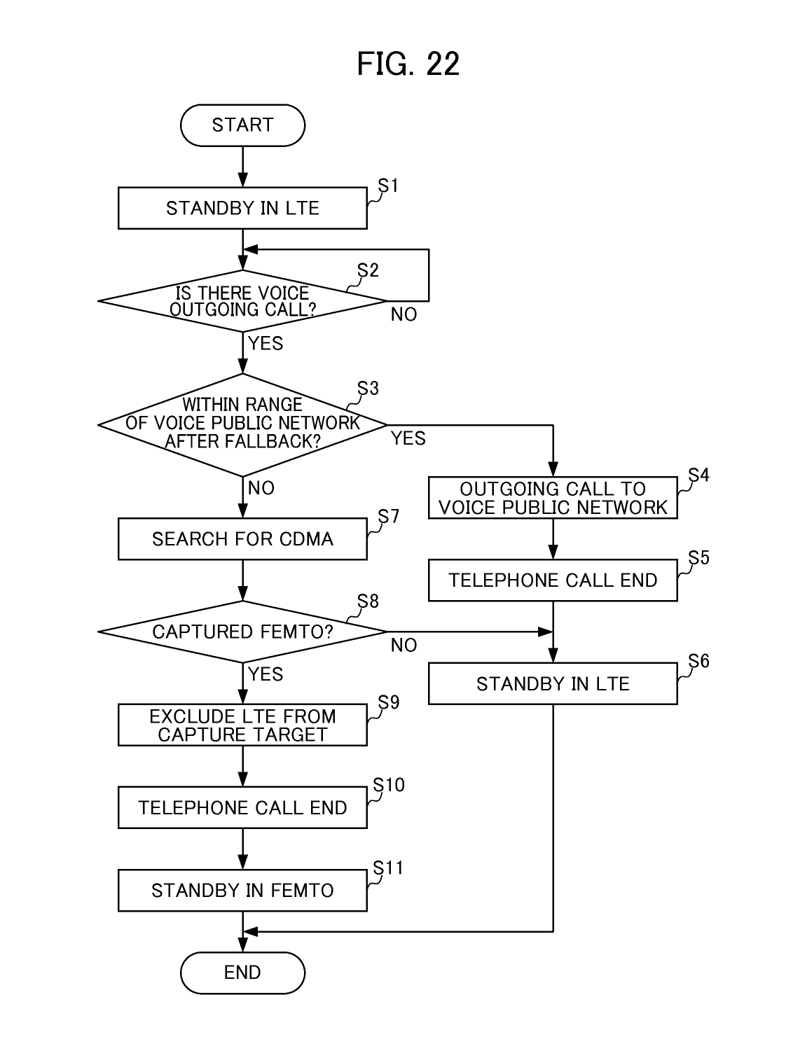

FIG. 22 is a flowchart showing voice outgoing call processing during standby of the LTE system in the smartphone 100.

In Step S1, a controller 110 performs standby of communication in the LTE system.

In Step S2, the controller 110 determines whether there was a voice outgoing call request. In the case of this determination being YES, the processing advances to Step S3, and in the case of the determination being NO, the processing continues Step S2.

In Step S3, the controller 110 attempts handover to the CDMA system by way of the CS fallback function. Then, the controller 110 determines whether the handover to the CDMA system succeeded, i.e. whether being within range of a voice public network after fall back. In the case of this determination being YES, the processing advances to Step S4, and in the case of the determination being NO, the processing advances to Step S7.

In Step S4, the controller 110 performs an outgoing call to the voice public network by the CDMA system of the handover destination.

In Step S5, the voice telephone call ends based on the outgoing call.

In Step S6, the controller 110 searches for the LTE system which is prioritized over the CDMA system, and transitions to a standby state for communication with the captured LTE system.

In Step S7, the controller re-attempts a voice outgoing call by searching for the CDMA system, due to failing in outgoing call by way of the CS fallback function. At this time, the communication system supporting femtocells is captured by prioritizing.

In addition, the controller 110 displays the status of this search on a display 102A, while searching for the CDMA system. More specifically, a picto display of the radio wave strength, a display prompting movement to a location at which the radio wave status is favorable, or the like is performed.

In Step S8, the controller 110 determines whether the communication system supporting femtocells was captured. In the case of this determination being YES, the processing advances to Step S9. On the other hand, in the case of the determination being NO, since it was not possible to capture the CDMA system, the processing advances to Step S6, and the controller 110 transitions to a standby state for communication with the LTE system.

In Step S9, the controller 110 suppresses handover from the CDMA system to the LTE system by excluding the LTE system from the capture targets when searching for communication systems.

In Step S10, the controller 110 performs voice telephone call processing based on the outgoing call with the communication system supporting femtocells, and waits for the end of the telephone call.

In Step S11, the controller 110 performs standby for communication by the communication system supporting femtocells continuously without returning to the LTE system after the end of the telephone call, since the LTE system is excluded from the capture targets.

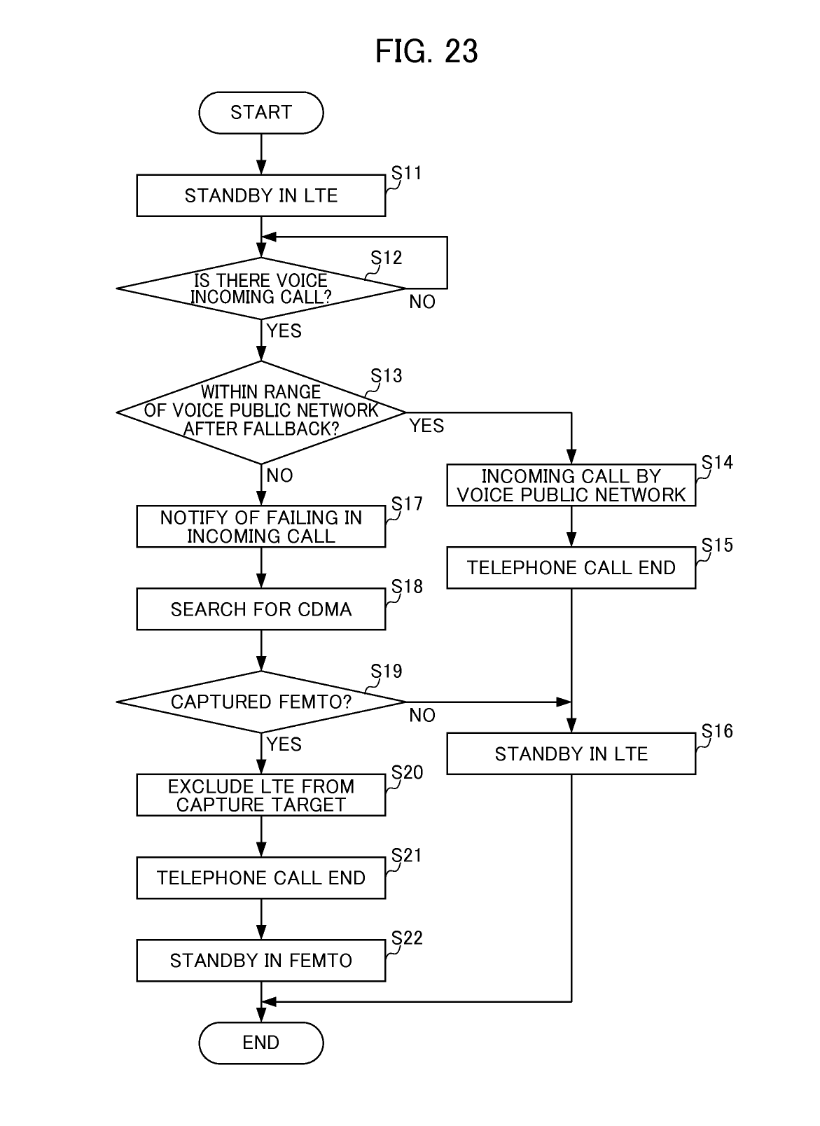

FIG. 23 is a flowchart showing voice incoming call processing during standby of the LTE system in the smartphone 100.

In Step S11, the controller 110 performs standby for communication of the LTE system.

In Step S12, the controller 110 determines whether a voice incoming call was notified by way of the CS fallback function. In the case of this determination being YES, the processing advances to Step S13, and in the case of the determination being NO, continues Step S12.

In Step S13, the controller 110 attempts handover to the CDMA system by way of the CS fallback function. Then, the controller 110 determines whether handover to the CDMA system succeeded, i.e. whether being within range of a voice public network after fallback. In the case of this determination being YES, the processing advances to Step S14, and in the case of the determination being NO, the processing advances to Step S17.

In Step S14, the controller 110 receives an incoming call from the voice public network by the CDMA system, which is the handover destination.

In Step S15, the voice telephone call ends based on the incoming call.

In Step S16, the controller 110 searches for the LTE system, which is prioritized over the CDMA system, and transitions to a standby state for communication with the captured LTE system.

In Step S17, the controller 110 notifies the user of having failed in call receiving by way of the CS fallback function. More specifically, the controller 110 displays the matter of having failed in call receiving on the display 102A, and prompts to move to within range of a voice public network.

In Step S18, the controller 110 re-attempts voice call receiving by searching for the CDMA system, due to having failed in call receiving by way of the CS fallback function. At this time, the communication system supporting femtocells is captured by prioritizing.

In addition, the controller 110 displays the status of this search on the display 102A while searching for the CDMA system. More specifically, a picto display of the radio wave strength, a display prompting movement to a location at which the radio wave status is favorable, or the like is performed.

In Step S19, the controller 110 determines whether having captured the communication system supporting femtocells. In the case of this determination being YES, the processing advances to Step S20. On the other hand, in the case of the determination being NO, since it was not possible to capture the CDMA system, the processing advances to Step S16, and the controller 110 transitions to a standby state for communication with the LTE system.

In Step S20, the controller 110 suppresses handover from the CDMA system to the LTE system, by excluding the LTE system from the capture targets when searching for communication systems.

In Step S21, the controller 110 stands by for an incoming call by the communication system supporting femtocells. In the case of there being an incoming call, the controller 110 transitions to voice telephone call processing and waits for the end of the telephone call.

In Step S22, the controller 110 performs standby for communication by the communication system supporting femtocells continuously without returning to the LTE system after the end of the telephone call, since the LTE system is excluded from the capture targets.

As mentioned above, according to the present embodiment, the smartphone 100 searches for the CDMA system in the case of having failed in outgoing call or call receiving by way of the CS fallback function. Therefore, with the smartphone 100, if capturing the communication system supporting femtocells as a result of a search, outgoing calls and incoming calls become possible by the communication system supporting femtocells; therefore, it avoids trouble of becoming outside range of the voice public network after handover by CS fallback and outgoing calls/incoming calls not being possible, and thus can comfortably carry out outgoing calls or incoming calls.

Furthermore, the smartphone 100 suppresses return to the LTE system after capturing the communication system supporting femtocells; therefore, continues standby with the communication system supporting femtocells, and can carry out outgoing calls or incoming calls comfortably, even if outside range of the voice public network.

In addition, since the smartphone 100 displays the status of a search while searching for the CDMA system, it can prompt a user to move to a location where voice telephone calls are possible.

In addition, in the case of having failed in call receiving by way of the CS fallback function, the smartphone 100 notifies the user of having failed in call receiving. Therefore, the user grasps that there was an incoming call, and can move to an area where a telephone call is possible. As a result thereof, the smartphone 100 can suppress inconvenience in the opportunity of a telephone call being lost.

In addition, the smartphone 100 can avoid a state in which communication is not possible due to standing by with the LTE system in the case of not having been able to capture the communication system supporting femtocells.

It should be noted that, upon standing by with the LTE system, the controller 110 may standby with the LTE system found as a result of a search; however, the controller 110 may standby with the LTE system for which standby had been carried out immediately prior to handover by the CS fallback function, so as to omit the search processing.

In the present embodiment, the smartphone 100 searches for the CDMA system in the case of having failed in an outgoing call or incoming call by way of the CS fallback function; however, it is not limited thereto. The smartphone 100, for example, may search for other systems so long as being a system supporting voice communication, even other than the CDMA system.

The configuration of the smartphone 100 shown in FIG. 21 is an example, and may be modified as appropriate within a scope that does not harm to gist of the present invention.

A part or the entirety of the program stored by the storage 109 in FIG. 21 may be downloaded from another device by wireless communication by way of the communication unit 106. In addition, a part or the entirety of the program stored by the storage 109 in FIG. 21 may be stored in a storage medium that can be read by a reading device included in the storage 109. In addition, a part or the entirety of the program stored by the storage 109 in FIG. 21 may be stored in a storage medium such as a CD, DVD or Blu-ray that is readable by a reading device connected to an external interface 114.

In addition, each program shown in FIG. 21 may be allocated to a plurality of modules, or may be combined with another program.

In addition, although a smartphone is explained as one example of a communication device in the present embodiment, the communication device is not limited to smartphones. For example, the communication device may be a portable electronic device such as a mobile phone, portable computer, digital camera, media player, electronic book reader, navigator or game console, or a communication dedicated module specializing in a communication function.

Although embodiments of the present invention are explained above, the present invention is not to be limited to the aforementioned embodiments. In addition, the effects described in the embodiment of the present invention are merely exemplifying the most favorable effects produced from the present invention, and the effects according to the present invention are not limited to those described in the aforementioned embodiments.

### EXPLANATION OF REFERENCE NUMERALS

1 mobile telephone device (communication device)
31 storage unit
32 communication unit
33 control unit
41 first communication control unit
42 second communication control unit
43 setting unit
100 smartphone (communication device)
102 touch-screen display
102A display (display unit)
102B touch screen
106 communication unit
110 controller (control unit)

1-10. (canceled)

11. A communication device comprising:
a communication controller configured to start a search for communication systems prioritizing a first communication system,
wherein the communication controller configured to start a search for communication systems except the first communication system when a search request is generated.

12. The communication device according to claim 11, further comprising an operation unit,
wherein the search request is caused by an operation on the operation unit.

13. The communication device according to claim 11, wherein the communication controller configured to maintain a state excluding the first communication system from a search target, when the communication controller performs standby for communication by a second communication system.

14. The communication device according to claim 13, wherein the second communication system is a communication system supporting a femtocell that has a smaller coverage area than a macrocell.

15. The communication device according to claim 13, wherein the communication controller configured to include the first communication system in the search target when the communication controller performs standby for communication by a communication system other than the second communication system.

16. The communication device according to claim 11, wherein the communication controller configured to include the first communication system in the search target when the communication controller fails to standby by any communication system.

17. The communication device according to claim 15, wherein the communication controller configured to start a search for communication systems from the first communication system after the communication controller include the first communication system in the search target.

18. (canceled)

19. The communication device according to claim 15, further comprising a setter,
wherein the communication controller includes the first communication system in the search target when the setter set to include the first communication system in the search target.

20. (canceled)

21. A communication control method for controlling a communication device comprising:
starting a search for communication systems except a first communication system when a search request is generated.

22. A communication device comprising:
a communication controller configured to start a search prioritizing a first communication system,
wherein the communication controller configured to exclude the first communication system from a search target when the communication controller performs standby for communication by a second communication system.

23. The communication device according to claim 22, wherein the communication controller configured to include the first communication system in a search target when the communication device is an outside range state or the communication controller performs standby for communication by a third communication system, after the communication controller excluded the first communication system from the search target.

24. The communication device according to claim 22, wherein the second communication system is a communication system including cell that has a smaller coverage area than a macrocell.

25. The communication device according to claim 23, wherein the third communication system is a communication system including a macrocell.

26. The communication device according to claim 23, further comprising a setter,
wherein the communication controller includes the first communication system in the search target when the setter set to include the first communication system in the search target.

27. The communication device according to claim 24, wherein the communication controller configured to include the first communication system in the search target when the communication controller performs standby for communication by a communication system other than the second communication system.

28. The communication device according to claim 22, wherein the communication controller configured to include the first communication system in the search target when the communication controller fails to standby for communication is not possible for any communication system.

29. The communication device according to claim 27, wherein the communication controller configured to start a search for communication systems from the first communication system after the communication controller include the first communication system in the search target.

30. (canceled)

31. A communication control method for controlling a communication device comprising:
excluding a first communication system from a search target when performing standby for communication by a second communication system.

32-39. (canceled)
